(19) United States
(12) Patent Application Publication
(10) Pub. No.: US 2016/0342747 A1
(43) Pub. Date: Nov. 24, 2016

(54) SYSTEMS AND METHODS FOR TRACKING TRENDS IN PATIENT DATA

(71) Applicant: AbbVie Biotechnology Ltd., Hamilton (BM)

(72) Inventor: Michael R. Sale, Libertyville, IL (US)

(21) Appl. No.: 15/157,796

(22) Filed: May 18, 2016

Related U.S. Application Data
(60) Provisional application No. 62/163,227, filed on May 18, 2015.

(51) Int. Cl. G06F 19/00

(52) U.S. Cl. CPC G06F 19/324; G06F 19/3456; G06F 19/3487

(57) ABSTRACT

A computer-implemented method for tracking electronic patient data over time is provided. The method includes retrieving, at a trend tracking computing device, electronic patient data from at least one server system, the electronic patient data including values acquired over a period of time for a plurality of parameters, the plurality of parameters including at least a lab parameter and a medication parameter, transmitting, in response to a user input on a healthcare provider (HCP) computing device, the electronic patient data to the HCP computing device from the trend tracking computing device, and controlling, using the trend tracking computing device, the HCP computing device to cause the electronic patient data to be displayed on the HCP computing device such that a user can observe trends in the electronic patient data over time.

### CROSS REFERENCE TO RELATED APPLICATIONS

This application claims priority to U.S. Provisional Patent Application No. 62/163,227, filed on May 18, 2015, the entire disclosure of which is hereby incorporated by reference in its entirety.

### FIELD OF USE

The disclosed subject matter relates to data processing between multiple computers in a digital data processing system and, more particularly, to aggregating and displaying patient data over a period of time such that trends in the patient data may be identified.

### BACKGROUND

In digital data processing systems, vast quantities of data may be stored in a large number of separate databases. Such digital data processing systems are prevalent in, for example, the financial industry, the healthcare industry, the automotive industry, the insurance industry etc. In these industries, data stored in different databases may have still common parameters (e.g., data associated with a specific entity, time, date, location, person, etc. may be stored in multiple databases).

However, data stored in different databases may be stored in different formats or encrypted using different encryption algorithms. Further, some data may be encrypted while other data remains unencrypted. Accordingly, when attempting to consolidate all data associated with a common parameter (e.g., to perform analytics on the data), it may be challenging to retrieve and combine all available data to generate a single, comprehensive record associated with the common parameter.

For example, when a patient is consulting with a healthcare provider (HCP) and/or undergoing a medical procedure (e.g., dialysis), the patient may be prescribed a plurality of drugs. A plurality of lab tests may also be performed for the patient. Accordingly, patient data associated with the patient may be generated at a lab, a pharmacy, a hospital, and/or an insurance company.

In at least some known healthcare systems, the HCP may have a server system that collects and stores patient data from the lab, pharmacy, etc. However, data from different entities (e.g., labs, pharmacies) may be stored in different formats. Accordingly, it may be difficult, for example, to quickly and effectively compare lab data with pharmacy data.

However, to monitor a patient and to facilitate improving a patient's condition, the HCP may wish to view the patient data in a format that enables the HCP to identify trends in the patient data. For example, it would be beneficial if the HCP were able to view lab data over a period of time and medication data over the period of time in a single display, such that the HCP can determine whether use of a particular medication corresponds to patient improvement discernable from the lab data.

### BRIEF DESCRIPTION OF THE DISCLOSURE

In one aspect, a computer-implemented method for tracking electronic patient data over time is provided. The method includes retrieving, at a trend tracking computing device, electronic patient data from at least one server system, the electronic patient data including values acquired over a period of time for a plurality of parameters, the plurality of parameters including at least a lab parameter and a medication parameter, transmitting, in response to a user input on a healthcare provider (HCP) computing device, the electronic patient data to the HCP computing device from the trend tracking computing device, and controlling, using the trend tracking computing device, the HCP computing device to cause the electronic patient data to be displayed on the HCP computing device such that a user can observe trends in the electronic patient data over time.

In another aspect, a trend tracking computing device for tracking electronic patient data over time is provided. The trend tracking computing device is configured to retrieve electronic patient data from at least one server system, the electronic patient data including values acquired over a period of time for a plurality of parameters, the plurality of parameters including at least a lab parameter and a medication parameter, transmit, in response to a user input on a healthcare provider (HCP) computing device, the electronic patient data to the HCP computing device from the trend tracking computing device, and control the HCP computing device to cause the electronic patient data to be displayed on the HCP computing device such that a user can observe trends in the electronic patient data over time.

In yet another aspect, a computer system for tracking electronic patient data over time is provided. The computer system includes a healthcare provider (HCP) computing device, at least one server system, and a trend tracking computing device communicatively coupled to the HCP computing device and the at least one server system. The trend tracking computing device is configured to retrieve electronic patient data from the at least one server system, the electronic patient data including values acquired over a period of time for a plurality of parameters, the plurality of parameters including at least a lab parameter and a medication parameter, transmit, in response to a user input on the HCP computing device, the electronic patient data to the HCP computing device from the trend tracking computing device, and control, the HCP computing device to cause the electronic patient data to be displayed on the HCP computing device such that a user can observe trends in the electronic patient data over time.

### BRIEF DESCRIPTION OF THE DRAWINGS

FIGS. 1-40 show example embodiments of the methods and systems described herein.

FIG. 1 is a simplified block diagram of an example patient data trend tracking system that includes a trend tracking computing device and other computing devices in accordance with one example embodiment of the present disclosure.

FIG. 2 is an expanded block diagram of an example embodiment of a server architecture of the patient data trend tracking system including the trend tracking computing device and a plurality of other computing devices in accordance with one example embodiment of the present disclosure.

FIG. 3 illustrates an example configuration of a healthcare provider (HCP) computing device that may be used with the system shown in FIGS. 1 and 2.

FIG. 4 illustrates an example configuration of a server system shown in FIGS. 1 and 2.

FIG. 5 illustrates an example architecture of a patient data trend tracking system.

FIG. 6 illustrates a schematic diagram of an example architecture for accessing data in the system shown in FIG. 5.

FIG. 7 illustrates a schematic diagram of an example architecture for performing scheduled updates in the system shown in FIG. 5.

FIGS. 8-40 illustrate screenshots of an example HCP user interface that may be displayed on the HCP computing device shown in FIG. 3.

Like numbers in the Figures indicate the same or functionally similar components.

### DETAILED DESCRIPTION OF THE DISCLOSURE

Embodiments of the methods and systems described herein enable retrieving and displaying patient data. More specifically, the patient data includes values acquired over time for a plurality of parameters, such as lab parameters and medication parameters. The patient data is displayed such that a user can identify trends in the patient data over time. The patient may be receiving any suitable therapeutic therapy, such as dialysis treatment, anti-inflammatory treatment (e.g., gastrointestinal treatment), treatment of the liver (e.g., for hepatitis C virus), oncology treatments, etc.

The methods and systems described herein may be implemented using computer programming or engineering techniques including computer software, firmware, hardware or any combination or subset thereof, wherein the technical effect is achieved by performing at least one of: (a) retrieving electronic patient data from at least one server system, the electronic patient data including values acquired over a period of time for a plurality of parameters, the plurality of parameters including at least a lab parameter and a medication parameter; (b) transmitting, in response to a user input on a healthcare provider (HCP) computing device, the electronic patient data to the HCP computing device; and (c) controlling the HCP computing device to cause the electronic patient data to be displayed on the HCP computing device such that a user can observe trends in the electronic patient data over time.

More specifically, the patient data trend tracking system described herein is specially programmed with computer code to perform the above processes. The technical effects described herein apply to the technical field of processing data transmitted through computer networks. The systems and methods described herein provide the technical advantage of receiving and organizing lab parameter data and medication parameter data for a patient over time using a computer network, and causing the organized data to be displayed to a user in an intuitive format that allows the user to quickly and easily identify trends in the data. Accordingly, the systems and methods described herein solve a technical problem (e.g., the inability of users of a computer network to quickly and efficiently access, view, and edit lab parameter data and medication parameter data for patients over time) by providing a technical solution rooted in computer technology (e.g., providing a computer architecture that organizes and displays lab parameter data and medication parameter data in a computer-network environment).

The embodiments described herein provide a patient data trend tracking system that includes a remote server, such as a cloud server. The cloud server includes, or is in communication with, a trend tracking computing device. The cloud server, using the trend tracking computing device, retrieves patient data from at least one server or database, and processes the patient data for display, such as on a healthcare provider (HCP) computing device.

In the example embodiment, the cloud server retrieves patient data from a dialysis clinic electronic medical record (EMR)/electronic health record (EHR) server. The dialysis clinic EMR/EHR server exchanges patient data with a plurality of servers and/or databases, such as a lab EMR/EHR server, a pharmacy EMR/EHR server, a hospital EMR/EHR server, and an insurance reimbursement system. Accordingly, the patient data is also stored on the dialysis clinic EMR/EHR server, and may include, for example, lab data (e.g., data associated with lab tests and results for one or more patients), prescription data (e.g., data associated with prescriptions for one or more patients), hospital data (e.g., hospital admission records, medical records, etc.), and reimbursement data (e.g., reimbursement amount and reimbursement status associated with a prescription, etc.).

The cloud server retrieves and stores (in an encrypted format) the patient data the from dialysis clinic EMR/EHR server. In the example embodiment, an HCP computing device is communicatively coupled to the cloud server. In response to user inputs on the HCP computing device, the cloud server transmits patient data to the HCP computing device for display on the HCP computing device, as described herein.

In the example embodiment, the HCP computing device displays an HCP user interface that displays a plurality of patient panels, each patient panel associated with an individual patient. For example, the patient panels may be associated with patients that attend a dialysis clinic. When a patient panel on the user interface is selected by a user (e.g., by the HCP), the cloud server transmits corresponding patient data to the HCP computing device for display.

The patient data includes values acquired over a period of time for a plurality of parameters. In the example embodiment, the parameters include lab parameters (e.g., calcium levels, phosphorous levels) and medication parameters (e.g., administered dosages of drug X) and/or other parameters (e.g., age, weight, blood pressure, etc.). The patient data may be displayed in a graph or a table format. In the example embodiment, a lab parameter may be displayed simultaneously with a medication parameter, such that the user can easily identify trends in the lab and medication parameters, as well as potential correlations between the lab and medication parameters. Further, predetermined ranges for at least some of the parameters may be displayed, and the display may indicate when particular values for a parameter fall outside of a predetermined range for that parameter.

In the example embodiment, the user can customize the display of patient information on the HCP computing device by specifying a time period for the patient data, specifying which parameters are to be displayed, and/or specifying the predetermined ranges associated with the parameters, as described herein.

The user may also update the patient data (e.g., by recording a medication administration) by inputting relevant patient/healthcare data using the HCP computing device. Further, the user may prescribe medication to a patient using the HCP computing device. For example, the user may enter prescription information (e.g., medication name and dosage), which is then transmitted to the pharmacy EMR/EHR server via the cloud server.

The user may also generate patient reports from the patient data by using the HCP computing device. The patient reports are customizable. For example, the user can select which parameters from the patient data are to be included in the patient report, and the user can also edit the text of the patient report.

In the example embodiment, patient data for multiple patients may also be displayed simultaneously on the HCP computing device. For example, the user may view a particular lab parameter across a patient population to ascertain how many patients have values of the lab parameter that fall outside of the predetermined range associated with the lab parameter.

The systems and methods described herein facilitate displaying patient data such that a user can easily identify trends on the patient data. The data is (i) retrieved, (ii) stored, (iii) transmitted to an HCP computing device in response to a user input, and (iv) caused to be displayed on the HCP computing device such that a user can easily identify trends in the patient data.

At least one of the technical problems addressed by the systems and methods described herein includes: (i) inability to display different types of patient data simultaneously; (ii) inability to display patient data graphically over time to enable a user to easily identify trends in the data; and (iii) inability to display values for lab parameters and medication parameters simultaneously such that a user can easily identify correlations between the lab and medication parameters. Certain embodiments described herein may address one or more of these technical problems in a prompt, relatively automated fashion.

The methods and systems described herein may be implemented using computer programming or engineering techniques including computer software, firmware, hardware, or any combination or subset thereof, wherein the technical effects may be achieved by performing at least one of the following steps: (a) retrieving electronic patient data from at least one server system, the electronic patient data including values acquired over a period of time for a plurality of parameters, the plurality of parameters including at least a lab parameter and a medication parameter; (b) transmitting, in response to a user input on a healthcare provider (HCP) computing device, the electronic patient data to the HCP computing device; and (c) controlling the HCP computing device to cause the electronic patient data to be displayed on the HCP computing device such that a user can observe trends in the electronic patient data over time.

The resulting technical effect achieved by the systems and methods described herein may include at least one of: (i) displaying different types of patient data simultaneously; (ii) displaying patient data graphically over time to enable a user to easily identify trends in the data; and (iii) displaying values for lab parameters and medication parameters simultaneously such that a user can easily identify correlations between the lab and medication parameters to generate a real world output.

The following detailed description illustrates embodiments of the disclosure by way of example and not by way of limitation. It is contemplated that the embodiments have general application to processing healthcare data in a variety of applications.

As used herein, the term “database” may refer to either a body of data, a relational database management system (RDBMS), or to both. As used herein, a database may include any collection of data including hierarchical databases, relational databases, flat file databases, object-relational databases, object-oriented databases, and any other structured collection of records or data that is stored in a computer system. The above examples are example only and thus are not intended to limit in any way the definition and/or meaning of the term database. Examples of RDBMS's include, but are not limited to including, Oracle® Database, MySQL, Teradata, IBM® DB2, Microsoft® SQL Server, Sybase®, and PostgreSQL. However, any database may be used that enables the systems and methods described herein. (Oracle is a registered trademark of Oracle Corporation, Redwood Shores, Calif.; IBM is a registered trademark of International Business Machines Corporation, Armonk, N.Y.; Microsoft is a registered trademark of Microsoft Corporation, Redmond, Wash.; and Sybase is a registered trademark of Sybase, Dublin, Calif.)

In one embodiment, a computer program is provided, and the program is embodied on a computer-readable medium. In an example embodiment, the system is executed on a single computer system, without requiring a connection to a sever computer. In a further embodiment, the system is being run in a Windows® environment (Windows is a registered trademark of Microsoft Corporation, Redmond, Wash.). In yet another embodiment, the system is run on a mainframe environment and a UNIX® server environment (UNIX is a registered trademark of X/Open Company Limited located in Reading, Berkshire, United Kingdom). The application is flexible and designed to run in various different environments without compromising any major functionality. In some embodiments, the system includes multiple components distributed among a plurality of computing devices. One or more components may be in the form of computer-executable instructions embodied in a computer-readable medium.

As used herein, an element or step recited in the singular and preceded with the word “a” or “an” should be understood as not excluding plural elements or steps, unless such exclusion is explicitly recited. Furthermore, references to “example embodiment” or “one embodiment” of the present disclosure are not intended to be interpreted as excluding the existence of additional embodiments that also incorporate the recited features.

The systems and processes are not limited to the specific embodiments described herein. In addition, components of each system and each process can be practiced independently and separate from other components and processes described herein. Each component and process also can be used in combination with other assembly packages and processes.

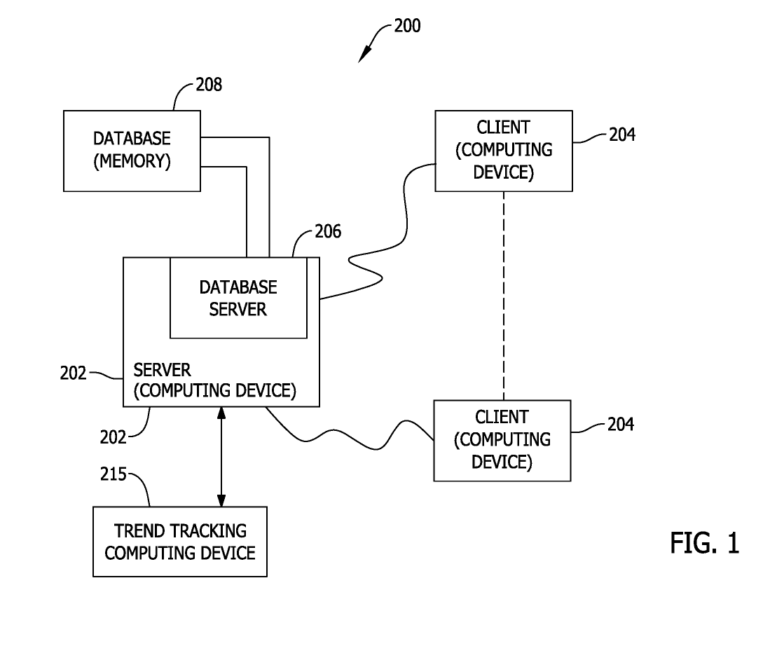

FIG. 1 is a simplified block diagram of one embodiment of a patient data trend tracking system 200 that includes a trend tracking computing device 215 in communication with a server system 202 that includes a database server 206. Further, a database 208 is in communication with server system 202 in the example embodiment. Trend tracking computing device 215 includes a processing device and a memory. System 200 further includes a plurality of client subsystems, also referred to as client systems 204 or client computing devices, connected to server system 202. In one embodiment, client systems 204 are computers including a web browser, such that server system 202 is accessible to client systems 204 using the Internet or another network. Client systems 204 are interconnected to the Internet or another network through many interfaces including a network, such as a local area network (LAN) and/or a wide area network (WAN), dial-in connections, cable modems, wireless-connections, and special high-speed ISDN lines. Client systems 204 may be any device capable of interconnecting to the Internet including a web-based phone, personal digital assistant (PDA), watch, medical device, kiosk, laptop computer, desktop computer, netbook, tablet, phablet, or other web-connectable equipment.

Database server 206 is connected to database 208 containing information on a variety of matters, as described below in greater detail. In one embodiment, database 208 is stored on server system 202 and may be accessed by potential users at one of client systems 204 by logging onto server system 202 through one of client systems 204. Database 208 is also accessible to trend tracking computing device 215. In an alternative embodiment, database 208 is stored remotely from server system 202 and may be non-centralized (e.g., in a cloud computing configuration). Server system 202 could be any type of computing device configured to perform the steps described herein. Additionally, trend tracking computing device 215 is in communication with server system 202. In some implementations, trend tracking computing device 215 is incorporated into or integrated within server system 202. As described herein, server system 202 retrieves and stores patient data such that the patient data can be transmitted to a computing device for display.

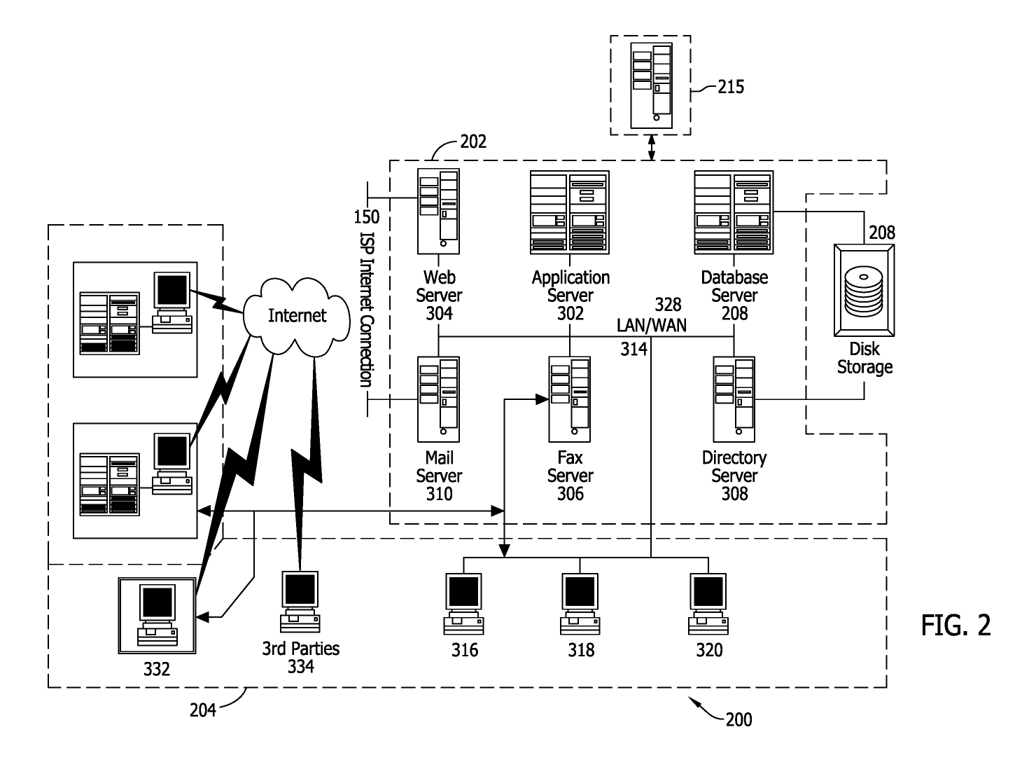

FIG. 2 is an expanded block diagram of an example embodiment of a server architecture of patient data trend tracking system 200 in accordance with one embodiment of the present disclosure. Patient data trend tracking system 200 includes client systems 204 and trend tracking computing device 215. Server system 202 includes database server 206, an application server 302, a web server 304, a fax server 306, a directory server 308, and a mail server 310. Database 208 (e.g., a disk storage unit), is coupled to database server 206 and directory server 308. Servers 206, 302, 304, 306, 308, and 310 are coupled in a local area network (LAN) 314. In addition, a system administrator's workstation 316, a user workstation 318, and a supervisor's workstation 320 are coupled to LAN 314. Alternatively, workstations 316, 318, and 320 are coupled to LAN 314 using an Internet link or are connected through an Intranet.

Each workstation, 316, 318, and 320, is a personal computer having a web browser. Although the functions performed at the workstations typically are illustrated as being performed at respective workstations 316, 318, and 320, such functions can be performed at one of many personal computers coupled to LAN 314. Workstations 316, 318, and 320 are illustrated as being associated with separate functions only to facilitate an understanding of the different types of functions that can be performed by individuals having access to LAN 314.

Server system 202 is configured to be communicatively coupled to various entities, including third parties 334 using an Internet connection 326. Server system 202 is also communicatively coupled to trend tracking computing device 215. In some embodiments, trend tracking computing device 215 is integrated within server system 202. The communication in the example embodiment is illustrated as being performed using the Internet, however, any other wide area network (WAN) type communication can be utilized in other embodiments, e.g., the systems and processes are not limited to being practiced using the Internet. In addition, and rather than WAN 328, local area network 314 could be used in place of WAN 328.

In the example embodiment, any authorized individual or entity having a workstation 330 may access system 200. At least one of the client systems includes a manager workstation 332 located at a remote location. Workstations 330 and 332 include personal computers having a web browser. Also, workstations 330 and 332 are configured to communicate with server system 202. Furthermore, fax server 306 communicates with remotely located client systems, including a client system 332, using a telephone link. Fax server 306 is configured to communicate with other client systems 316, 318, and 320 as well.

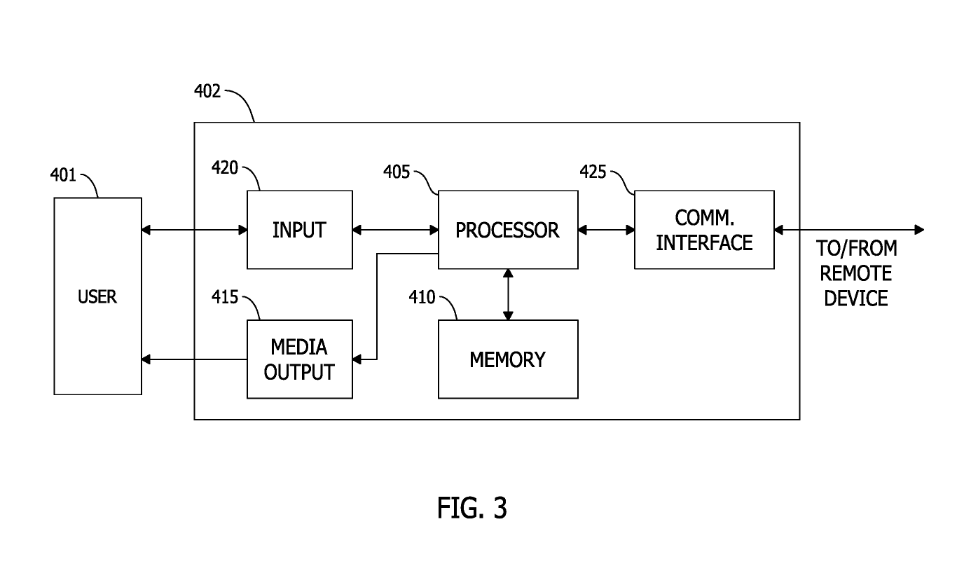

FIG. 3 illustrates an example configuration of a health care provider (HCP) computing device 402 operated by a user 401. HCP computing device 402 enables user 401 to view trends in patient data, record administrations of medication, prescribe medication, generate patient reports, and assess clinic performance, as described in detail herein. HCP computing device 402 may include, but is not limited to, client systems (“client computing devices”) 204, 316, 318, and 320, workstation 330, and manager workstation 332 (shown in FIG. 2).

HCP computing device 402 includes one or more processors 405 for executing instructions. In some embodiments, executable instructions are stored one or more memory devices 410. Processor 405 may include one or more processing units (e.g., in a multi-core configuration). One or more memory devices 410 are any one or more devices allowing information such as executable instructions and/or other data to be stored and retrieved. One or more memory devices 410 may include one or more computer-readable media.

HCP computing device 402 also includes at least one media output component 415 for presenting information to user 401. Media output component 415 is any component capable of conveying information to user 401. In some embodiments, media output component 415 includes an output adapter such as a video adapter and/or an audio adapter. An output adapter is operatively coupled to processor 405 and operatively couplable to an output device such as a display device (e.g., a liquid crystal display (LCD), organic light emitting diode (OLED) display, cathode ray tube (CRT), or “electronic ink” display) or an audio output device (e.g., a speaker or headphones).

In some embodiments, HCP computing device 402 includes an input device 420 for receiving input from user 401. Input device 420 may include, for example, a keyboard, a pointing device, a mouse, a stylus, a touch sensitive panel (e.g., a touch pad or a touch screen), a gyroscope, an accelerometer, a position detector, an audio input device, or a medical diagnostic device (e.g., a thermometer, blood pressure measuring device, heart rate monitor, etc.). A single component such as a touch screen may function as both an output device of media output component 415 and input device 420.

HCP computing device 402 may also include a communication interface 425, which is communicatively couplable to a remote device such as server system 202. Communication interface 425 may include, for example, a wired or wireless network adapter or a wireless data transceiver for use with a mobile phone network (e.g., Global System for Mobile communications (GSM), 3G, 4G or Bluetooth) or other mobile data network (e.g., Worldwide Interoperability for Microwave Access (WIMAX)).

Stored in one or more memory devices 410 are, for example, computer-readable instructions for providing a user interface to user 401 via media output component 415 and, optionally, receiving and processing input from input device 420. A user interface may include, among other possibilities, a web browser and client application. Web browsers enable users, such as user 401, to display and interact with media and other information typically embedded on a web page or a web site from server system 202. A client application allows user 401 to interact with a server application from server system 202 or a web server.

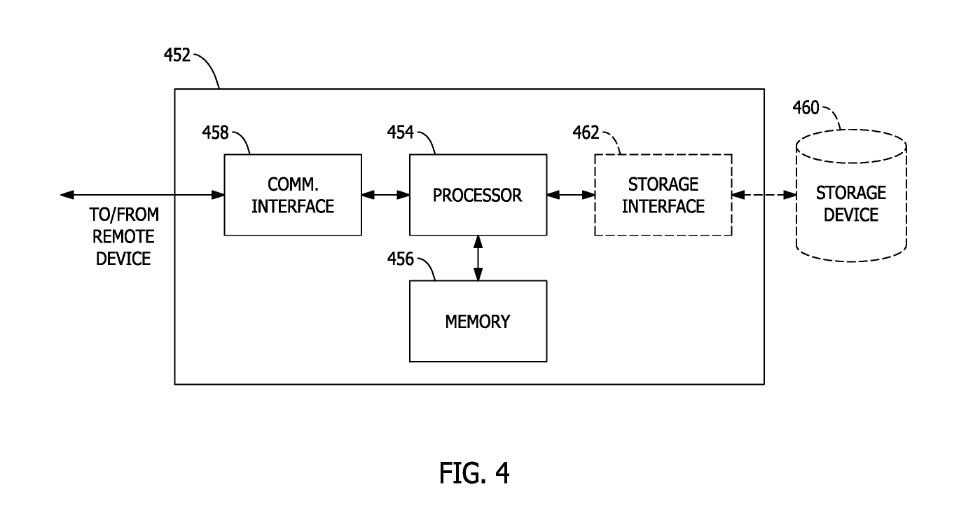

FIG. 4 illustrates an example configuration of a server computing device 452 such as server system 202 (shown in FIGS. 1 and 2). Server computing device 452 may include, but is not limited to, database server 206, application server 302, web server 304, fax server 306, directory server 308, and mail server 310. Server computing device 452 is also representative of trend tracking computing device 215.

Server computing device 452 includes one or more processors 454 for executing instructions. Instructions may be stored in one or more memory devices 456, for example. One or more processors 454 may include one or more processing units (e.g., in a multi-core configuration).

One or more processors 454 are operatively coupled to a communication interface 458 such that server computing device 452 is capable of communicating with a remote device such as HCP computing device 402 or another server computing device 452. For example, communication interface 458 may receive requests from client systems 204 via the Internet or another network, as illustrated in FIGS. 1 and 2.

One or more processors 454 may also be operatively coupled to one or more storage devices 460. One or more storage devices 460 are any computer-operated hardware suitable for storing and/or retrieving data. In some embodiments, one or more storage devices 460 are integrated in server computing device 452. For example, server computing device 452 may include one or more hard disk drives as one or more storage devices 460. In other embodiments, one or more storage devices 460 are external to server computing device 452 and may be accessed by a plurality of server computing devices 452. For example, one or more storage devices 460 may include multiple storage units such as hard disks or solid state disks in a redundant array of inexpensive disks (RAID) configuration. One or more storage devices 460 may include a storage area network (SAN) and/or a network attached storage (NAS) system. In some embodiments, one or more storage devices 460 may include database 208.

In some embodiments, one or more processors 454 are operatively coupled to one or more storage devices 460 via a storage interface 462. Storage interface 462 is any component capable of providing one or more processors 454 with access to one or more storage devices 460. Storage interface 462 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing one or more processors 454 with access to one or more storage devices 460.

One or more memory devices 410 and 456 may include, but are not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). The above memory types are example only, and are thus not limiting as to the types of memory usable for storage of a computer program.

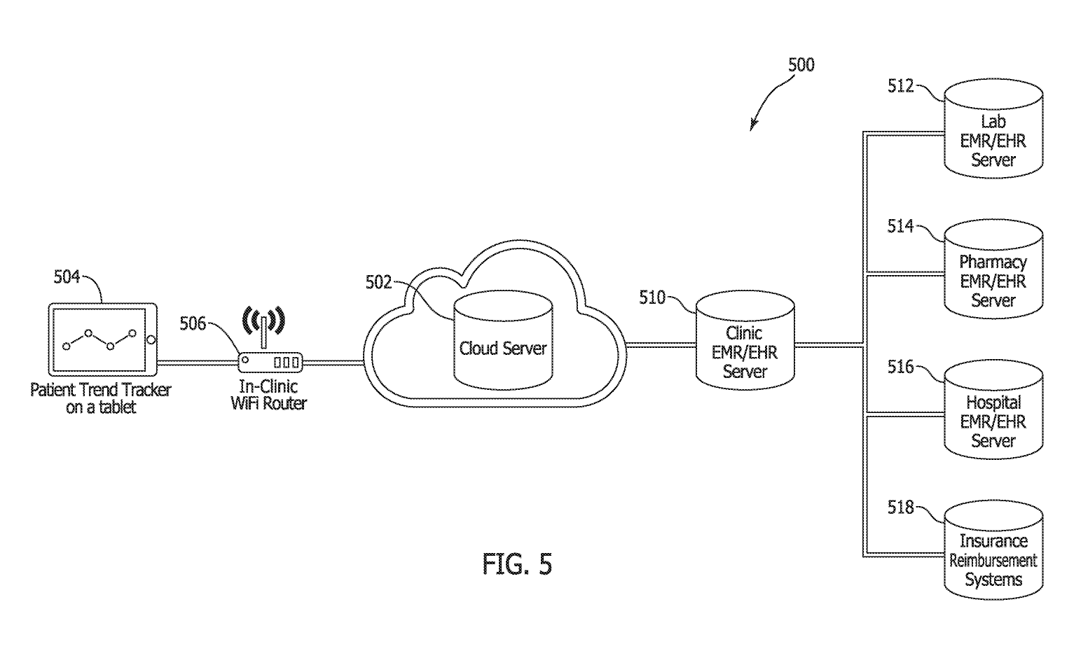

FIG. 5 illustrates an example architecture of a patient data trend tracking system 500, such as patient data trend tracking system 200 (shown in FIGS. 1 and 2). In the example embodiment, system 500 includes a cloud server 502, such as server 202. Accordingly, cloud server 502 may include or be in communication with trend tracking computing device 215. As described herein, using trend tracking computing device 215, cloud server 502 retrieves data from at least one server and/or database and processes it for display on an HCP computing device 504, such as HCP computing device 402 (shown in FIG. 3).

In the example embodiment, patient data trend tracking system 500 is used to track and display patient data for patients that receive dialysis at a dialysis clinic. Alternatively, as will be appreciated by those of skill in the art, patient data trend tracking system 500 may be used to display and track patient data for any suitable group of patients. The patient trend tracking system 500 also may be used in a clinical trials setting for displaying patient and clinical data for review by HCPs and investigators.

In the example embodiment, HCP computing device 504 is a tablet having a touch-screen interface. Alternatively, HCP computing device 504 may be any suitable computing device having any suitable outputs and inputs. Cloud server 502 may be communicatively coupled to HCP computing device 504 via a wireless router 506 located at the dialysis clinic. Alternatively, HCP computing device 504 may be communicatively coupled to cloud server 502 using any appropriate communications media and/or technology. In some examples the data transmission in the system 500 may be restricted to within a predetermined region, such as within a dialysis clinic.

As shown in FIG. 5, cloud server 502 is communicatively coupled to a clinic electronic medical record (EMR)/electronic health record (EHR) server 510 such as a clinic EMR in the example embodiment. Clinic EMR/EHR server 510 is communicatively coupled to a plurality of servers and/or databases. For example, clinic EMR/EHR server 510 may be communicatively coupled to and exchange patient data with a lab EMR/EHR server 512, a pharmacy EMR/EHR server 514, a hospital EMR/EHR server 516, and an insurance reimbursement system 518. Insurance reimbursement system 518 may be operated, for example, by a government entity. In the example embodiment, clinic EMR/EHR server 510 exchanges lab data (e.g., data associated with lab tests and results for the patient) with lab EMR/EHR server 512, exchanges prescription data (e.g., data associated with prescriptions for the patient) with pharmacy EMR/EHR server 514, exchanges hospital data (e.g., hospital admission records, medical records, etc.) with hospital EMR/EHR server 516, and exchanges insurance reimbursement data (e.g., reimbursement amount and reimbursement status associated with a prescription, etc.) with insurance reimbursement system 518.

In the example embodiment, various patient data (e.g., basic patient information, lab data, prescription data, hospital data, insurance reimbursement data, etc.) is stored on clinic EMR/EHR server 510 in an encrypted format. Cloud server 502 retrieves the patient data from dialysis clinic EMR/EHR server 510 and stores the patient data on cloud server 502, where the patient data remains encrypted. The trend tracking computing device 215 facilitates HCP computing device 504 accessing the patient data stored on cloud server 502. Specifically, the patient data is decrypted and displayed on HCP computing device 504, as described herein. Further, the user may use HCP computing device 504 to push data (e.g., prescription data and medication administration data) to clinic EMR/EHR server 510 via cloud server 502, as described herein. The patient data (e.g., for patients that attend the dialysis clinic, or patients taking part in a clinical trial) is retrieved from cloud server 502 and displayed in a variety of formats, as described herein. Specifically, in the example embodiment, HCP computing device 504 includes a software application stored thereon that facilitates receiving and displaying data from cloud server 502.

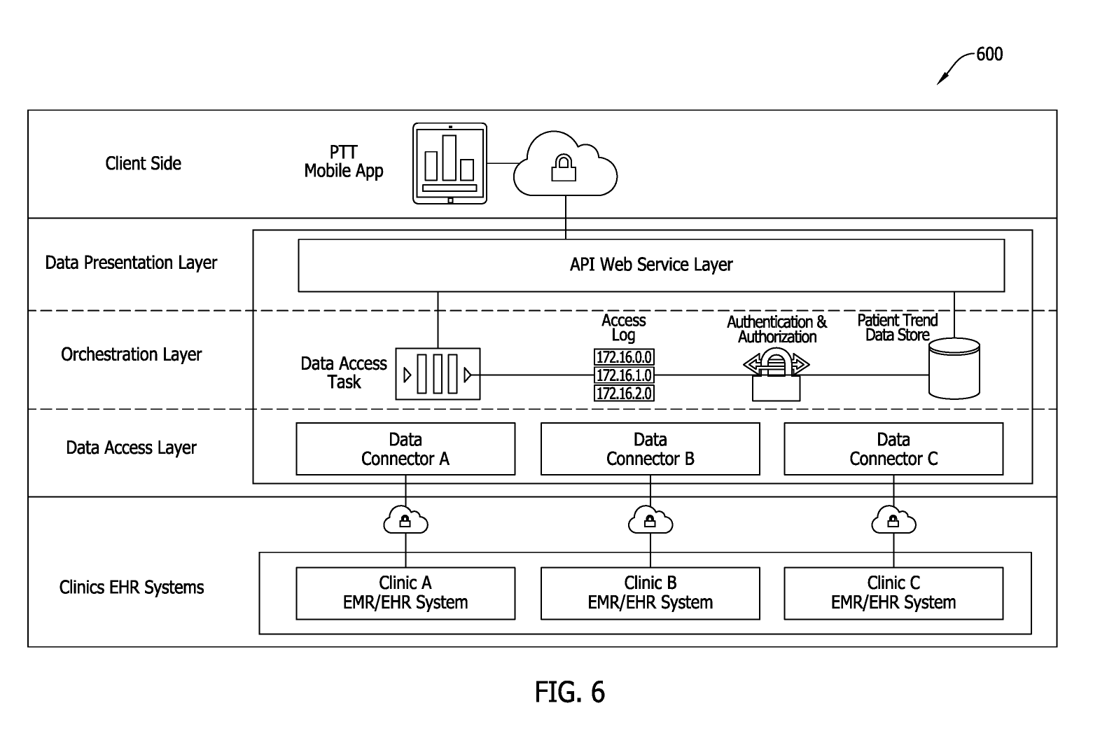

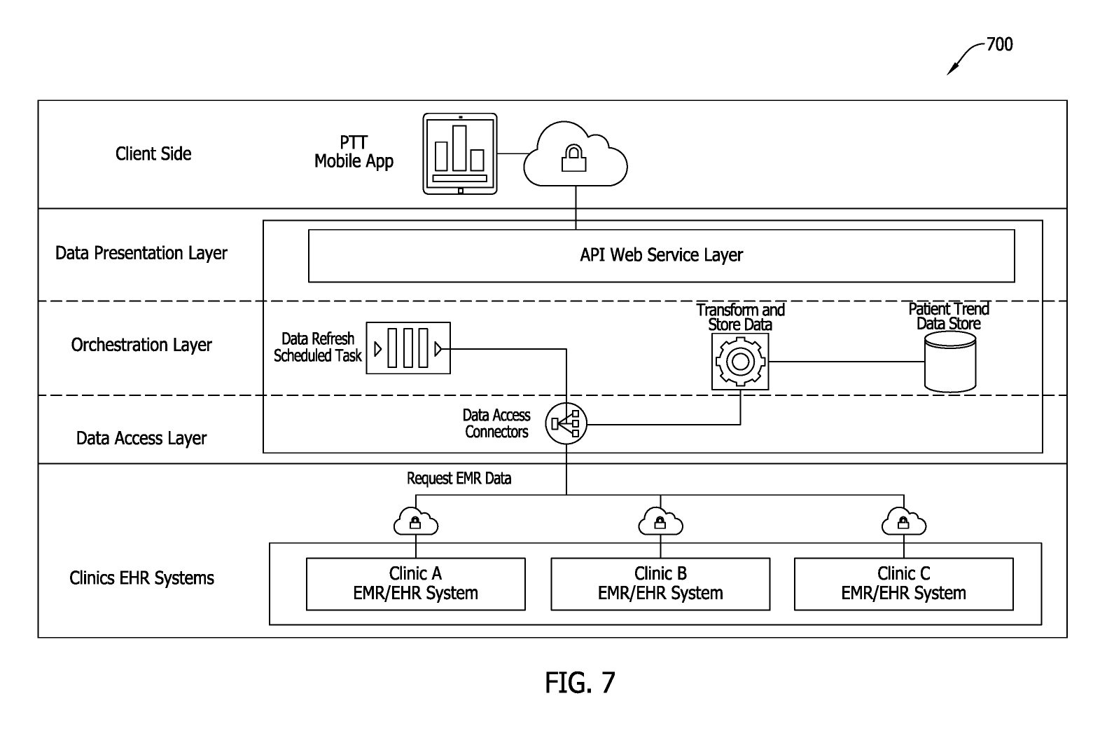

FIG. 6 is a schematic diagram of an example architecture 600 for accessing data in patient data trend tracking system 500. FIG. 7 is a schematic diagram of an example architecture 700 for performing scheduled updates in patient data trend tracking system 500.

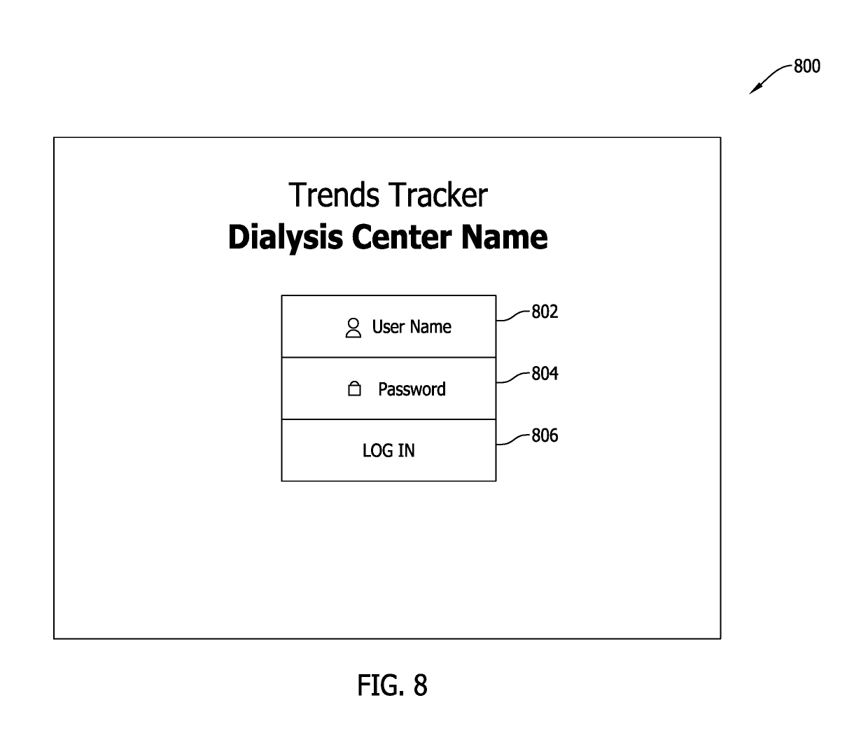

FIGS. 8-40 are screenshots of an example HCP user interface that may be displayed, for example, on HCP computing device 504 during operation of system 500.

FIG. 8 is a screenshot of an example login window 800. To login, the user enters a username in a user field 802, enters a password in a password field 804, and selects a log in button 806.

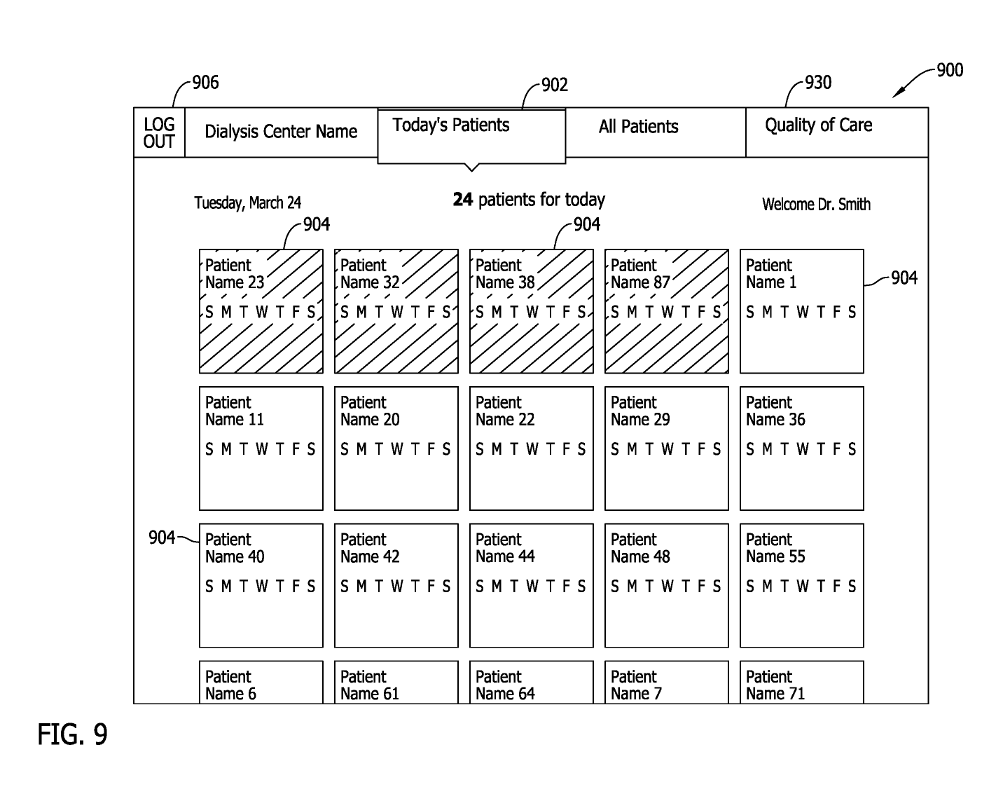

FIG. 9 is a screenshot of an example dashboard window 900 with a today's patients tab 902 selected. As shown in FIG. 9, when today's patients tab 902 is selected, dashboard window 900 displays a patient panel 904 for each patient attending the dialysis center on the current day. To return to login window 800, a user selects a log out button 906. In the example embodiment, the user can scroll up and down to view additional patient panels 904.

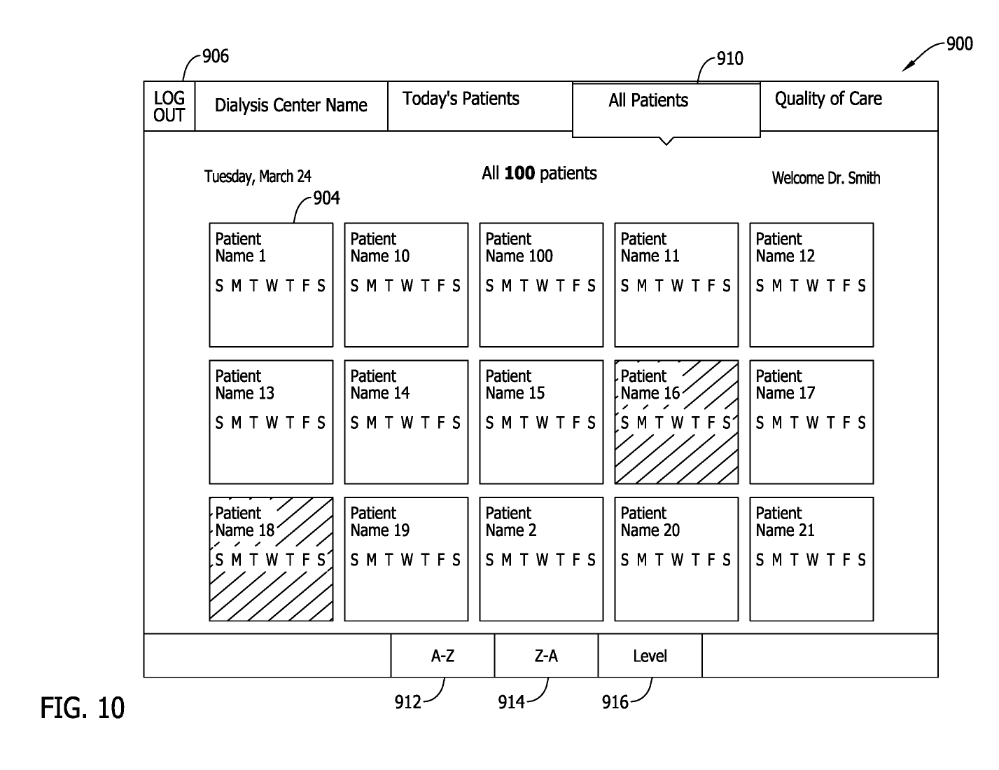

FIG. 10 is a screenshot of dashboard window 900 with an all patients tab 910 selected. When all patients tab 910 is selected, patient panels 904 for all patients of the dialysis clinic (e.g., not just the patients for that day) are displayed. By selecting an A-Z sort button 912, patient panels 904 are sorted in alphabetical order by name. By selecting a Z-A sort button 914, patient panels 904 are sorted in a reverse alphabetical order. In other examples, patient panels 904 may be sorted in any suitable manner, such as by age, location, symptoms, current medications, or any other demographic or health related information.

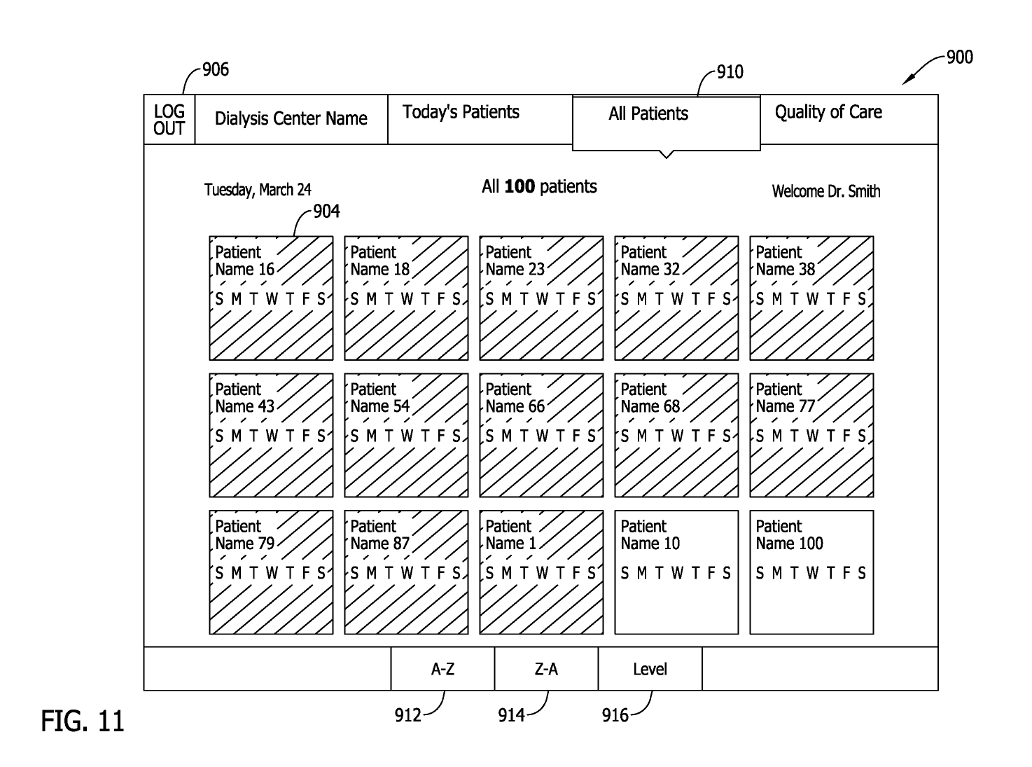

As shown in FIG. 11, by selecting a level sort button 916, patient panels 904 are sorted according to whether an associated patient has a lab value outside of a predetermined range. In the example embodiment, patient panels 904 for patients that have a lab value (e.g., a blood value) outside of a predetermined range are displayed in a different color (e.g., orange) than patient panels 904 for patients that have lab values within the predetermined range.

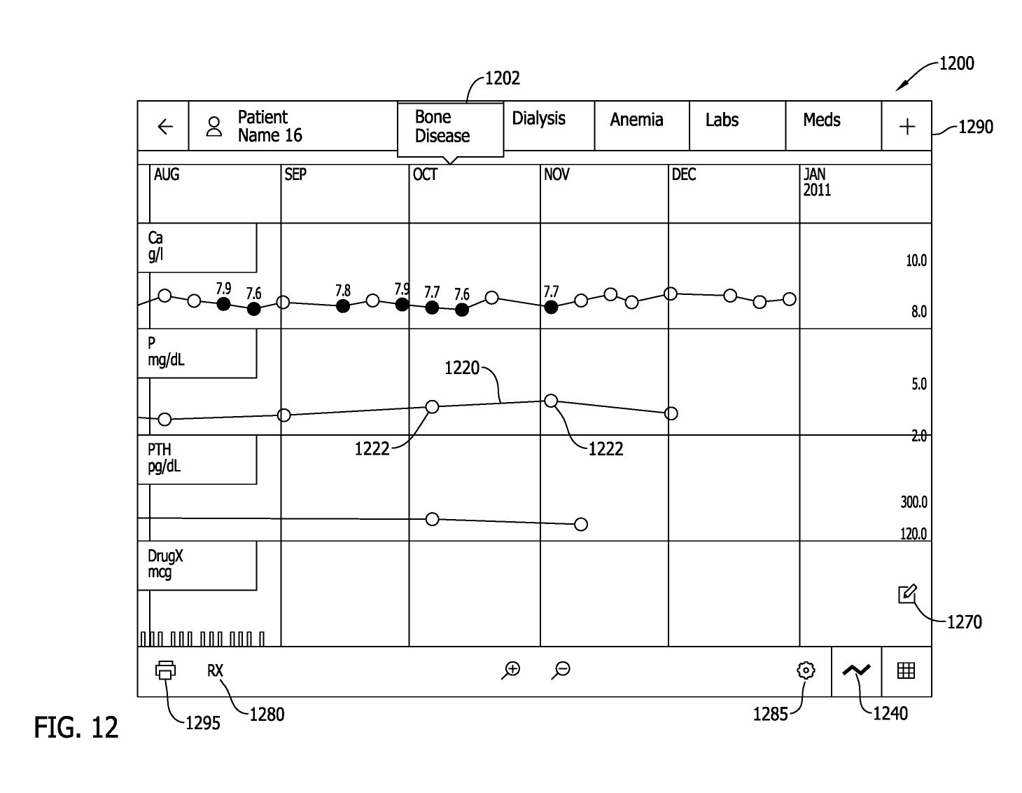

FIG. 12 is a screenshot of a patient data window 1200 with a bone disease tab 1202 selected. Patient data window 1200 is displayed in response to the user selecting a particular patient panel 904 (e.g., from dashboard window 900 when either today's patients tab 902 or all patients tab 910 is selected). In the example embodiment, when the user selects a patient panel 904, the patient data for that particular patient panel 904 is transmitted from cloud server 502 for display on HCP computing device 504.

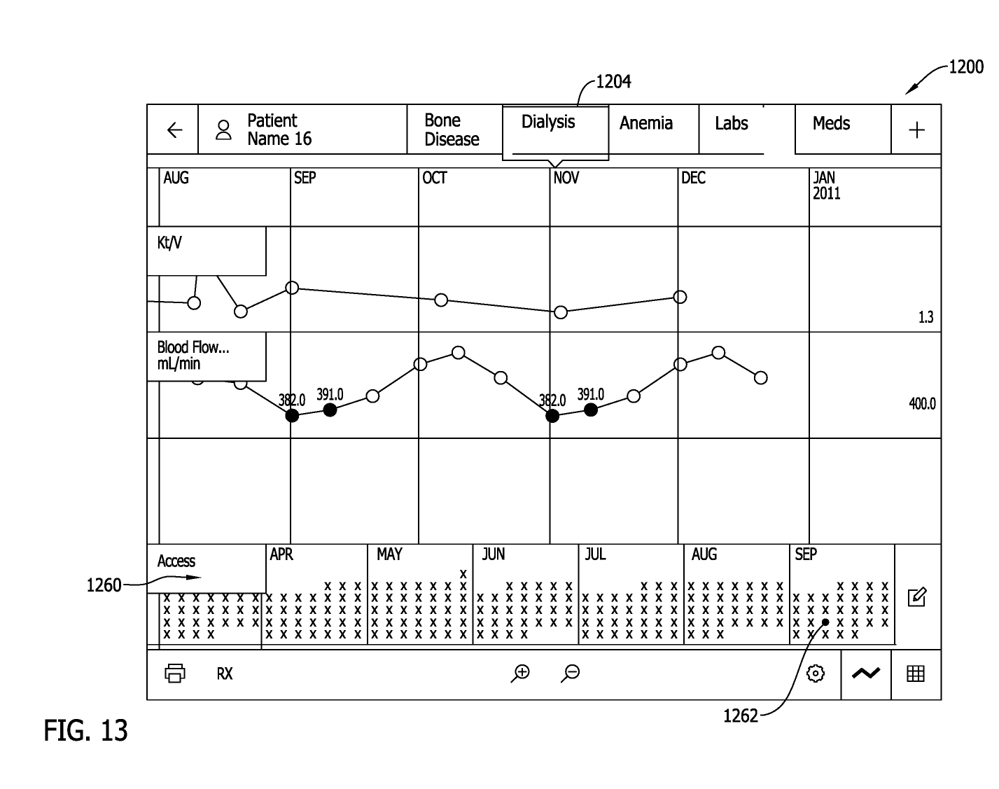

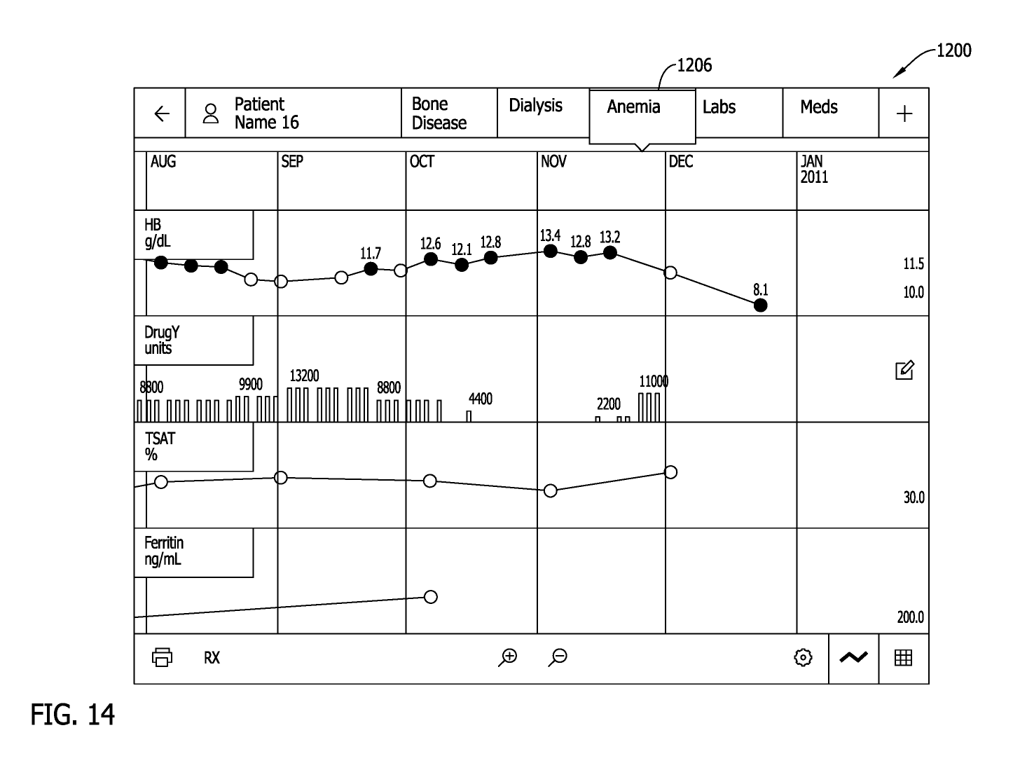

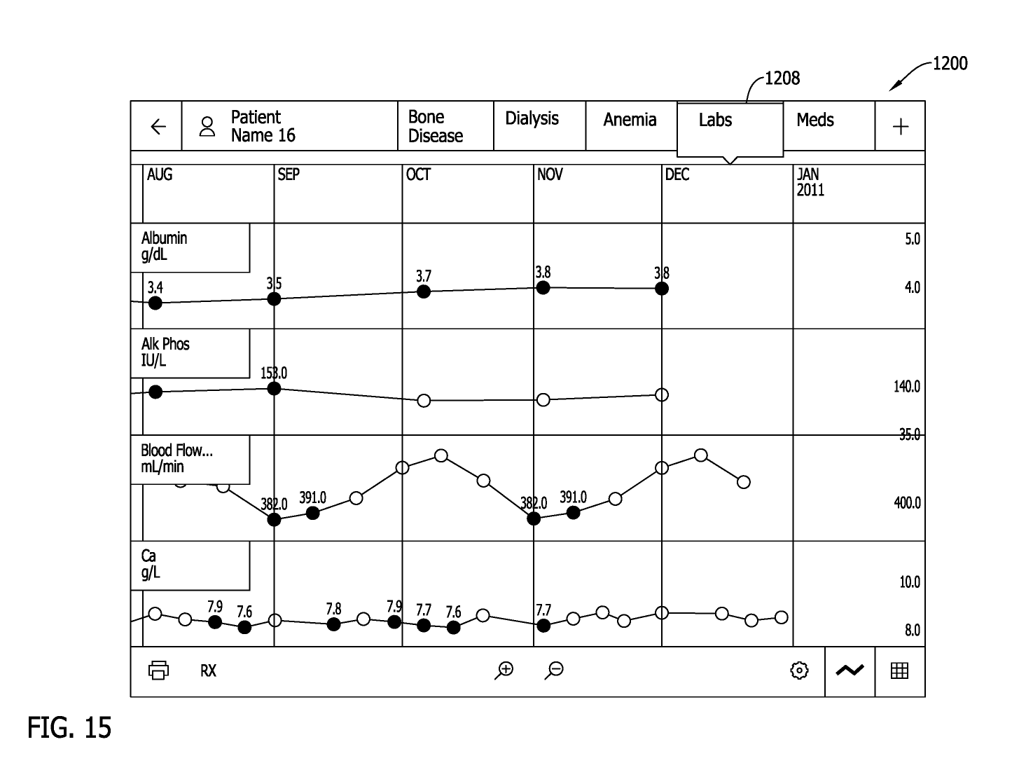

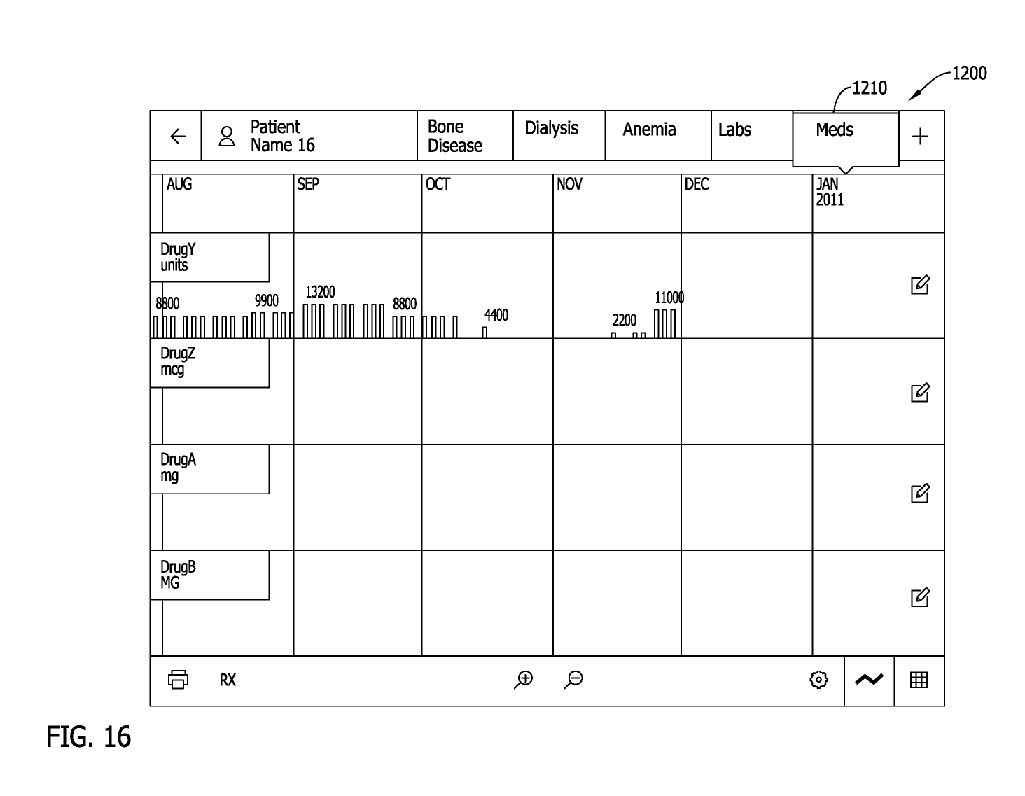

FIG. 13 is a screenshot of patient data window 1200 with a dialysis tab 1204 selected, FIG. 14 is a screenshot of patient data window 1200 with an anemia tab 1206 selected, FIG. 15 is a screenshot of patient data window 1200 with a labs tab 1208 selected, and FIG. 16 is a screenshot of patient data window 1200 with a meds tab 1210 selected.

As shown in FIGS. 12-16, depending on which tab is selected, different patient data is shown in patient data window 1200. However, regardless of which tab is selected, patient data window 1200 displays patient data over a period of time for a plurality of parameters such that trends in the patient data may be observed by the user. In the example embodiment, the displayed parameters include lab parameters (e.g., calcium levels, phosphorous levels) and medication parameters (e.g., administered dosages of drug X). The medication parameter may be associated with, for example, a drug used for the prevention and treatment of secondary hyperparathyroidism, such as paricalcitol. For example, the medication parameter may be associated with the drug Zemplar®. Zemplar® is a registered trademark of Abbvie Inc. of North Chicago, Ill. The user can scroll up and down on patient data window 1200 to display additional patient data, if present. Further, the user can scroll left and right to change the displayed time period to observe additional trends in the displayed data.

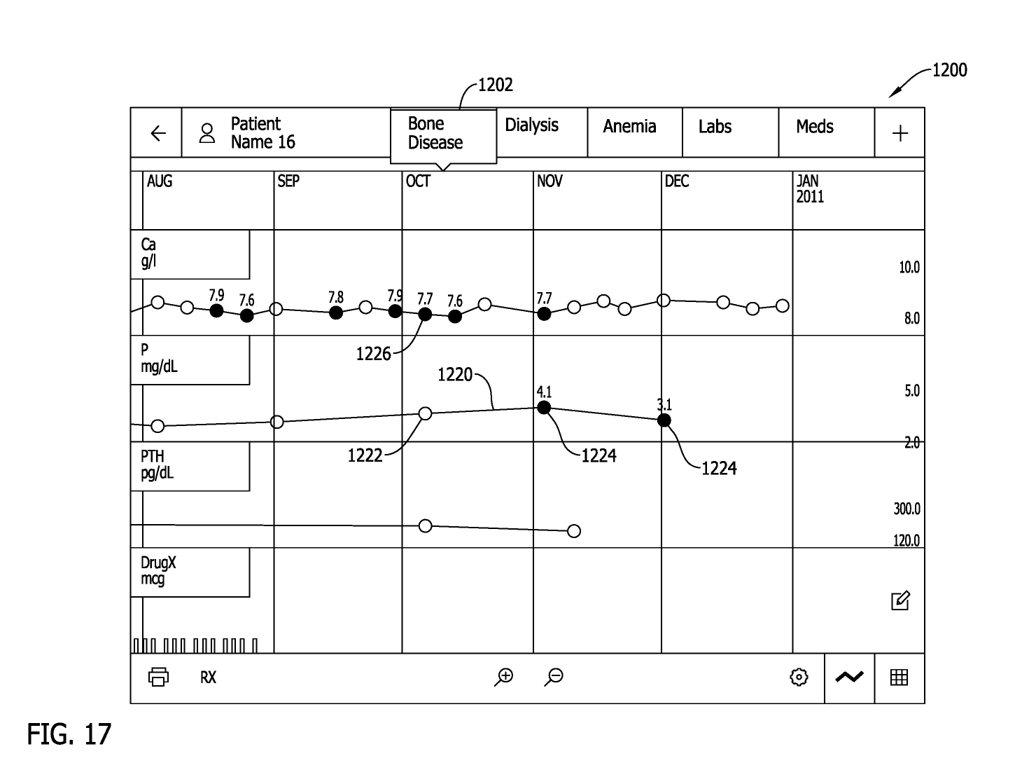

Referring back to FIG. 12, the patient data for at least some of the parameters (e.g., calcium, phosphorous) includes a curve 1220 generated by connecting discrete data points 1222. As shown in FIG. 17, when a user selects data points 1222, the values of the selected data points 1224 are shown. Further, in the example embodiment, values for data points 1222 that lie outside a predetermined range may also be displayed, and those outlier data points 1226 may be displayed in a different color (e.g., orange).

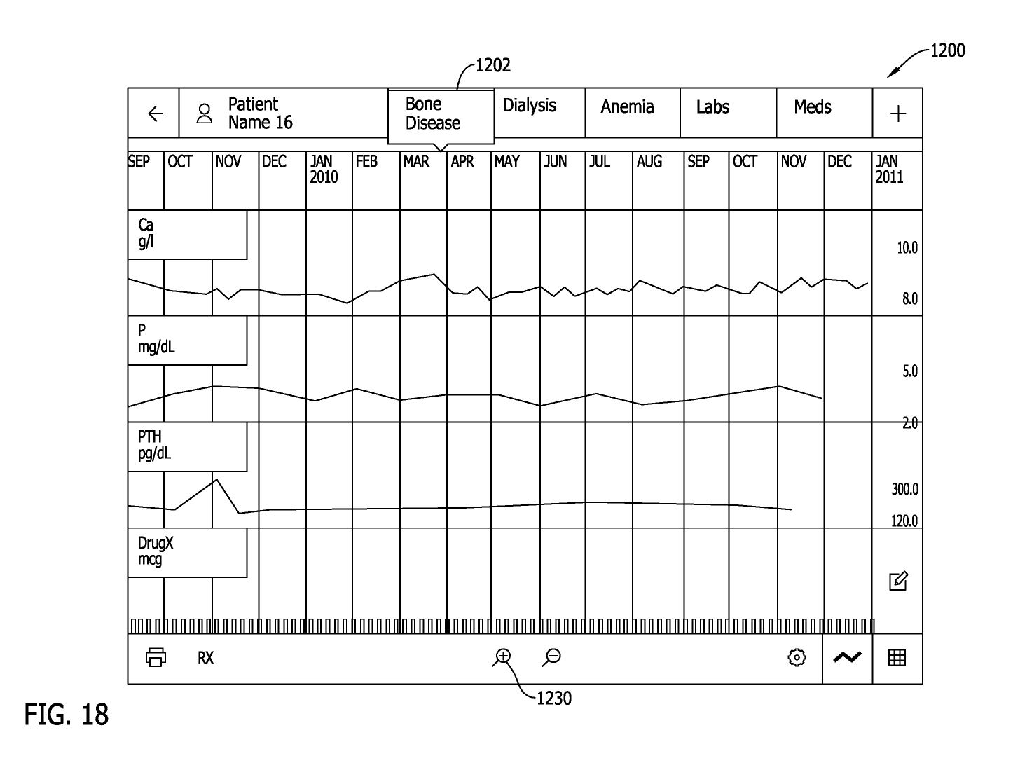

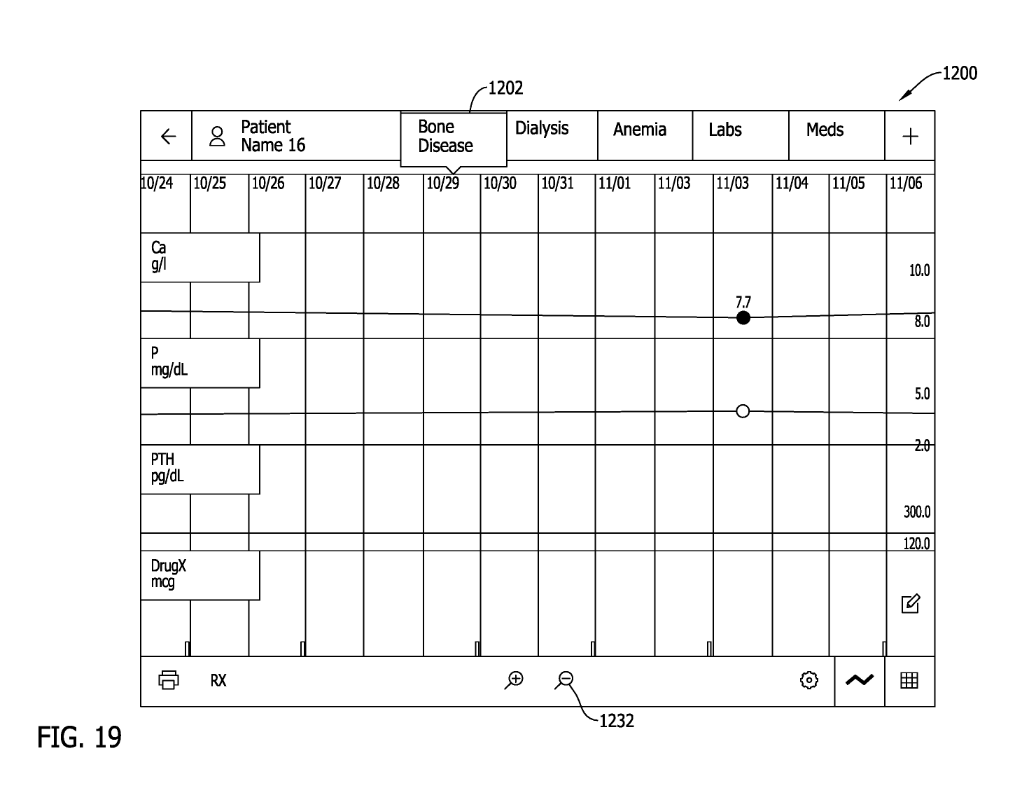

The displayed time period on patient data window 1200 may also be adjusted by selecting zoom buttons. FIG. 18 shows patient data window 1200 after a zoom out button 1230 has been selected, and FIG. 19 shows patient data window 1200 after a zoom in button 1232 has been selected.

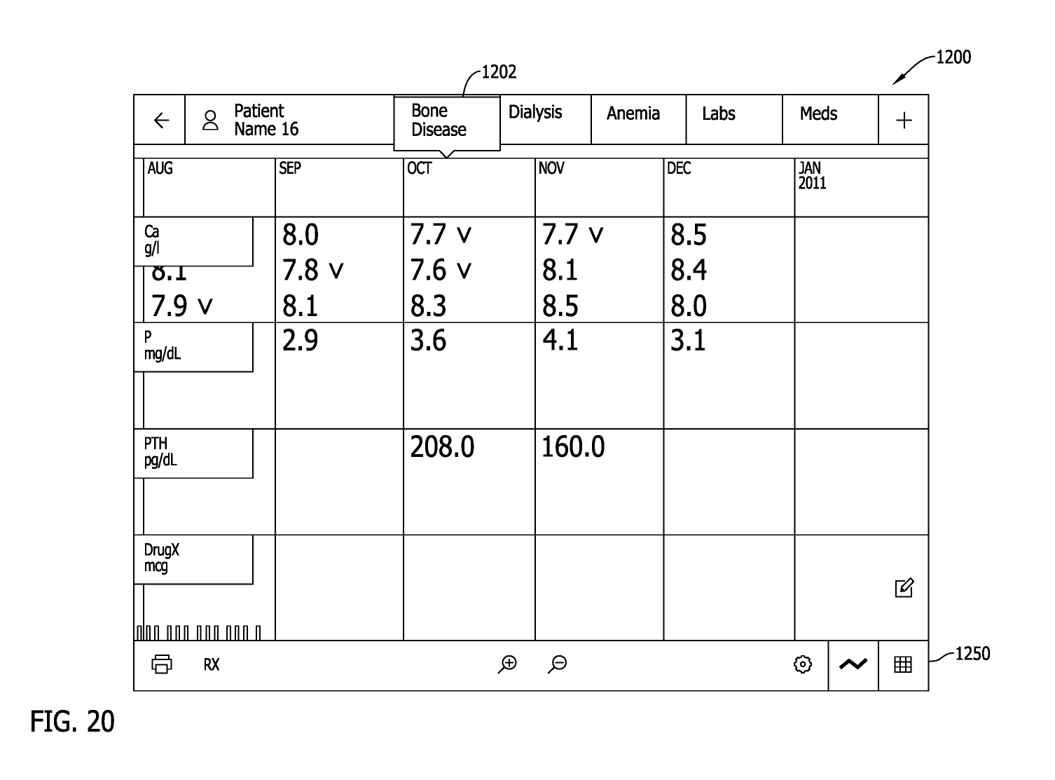

In FIGS. 12-19, a graphical view button 1240 is selected, and accordingly, the patient data is shown in a graphical view. FIG. 20 shows a screenshot of patient data window 1200 when a table view button 1250 is selected. As shown in FIG. 20, the patient data is displayed in a table format, instead of a graph, when table view button 1250 is selected.

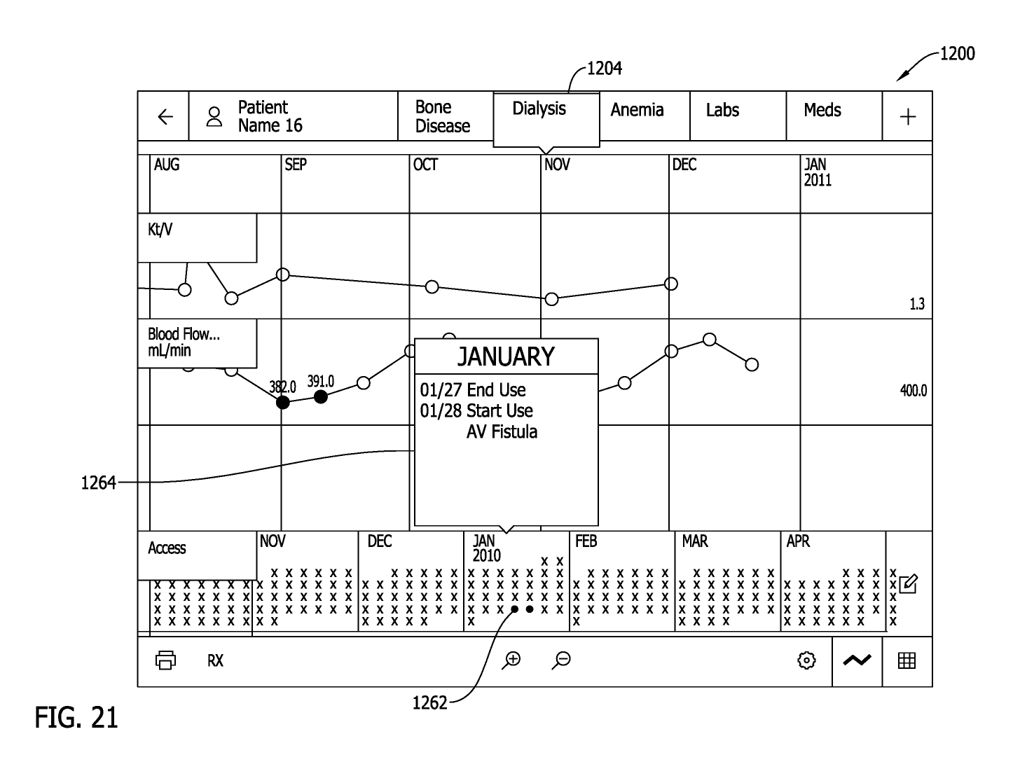

Referring back to FIG. 13, when dialysis tab 1204 is selected, patient data window includes an access section 1260. Within access section 1260, dots 1262 indicate days on which one or more access issues were logged for the patient. The access issues may include specific actions taken with respect to the patient's vascular access, such as starting, stopping, and/or surgical interventions such as stenosis or replacement. The access issues may also be notations on issues such as infection, thrombosis, or hemorrhage. If the user selects a dot 1262, a window 1264 listing the access issues is displayed, as shown in FIG. 21.

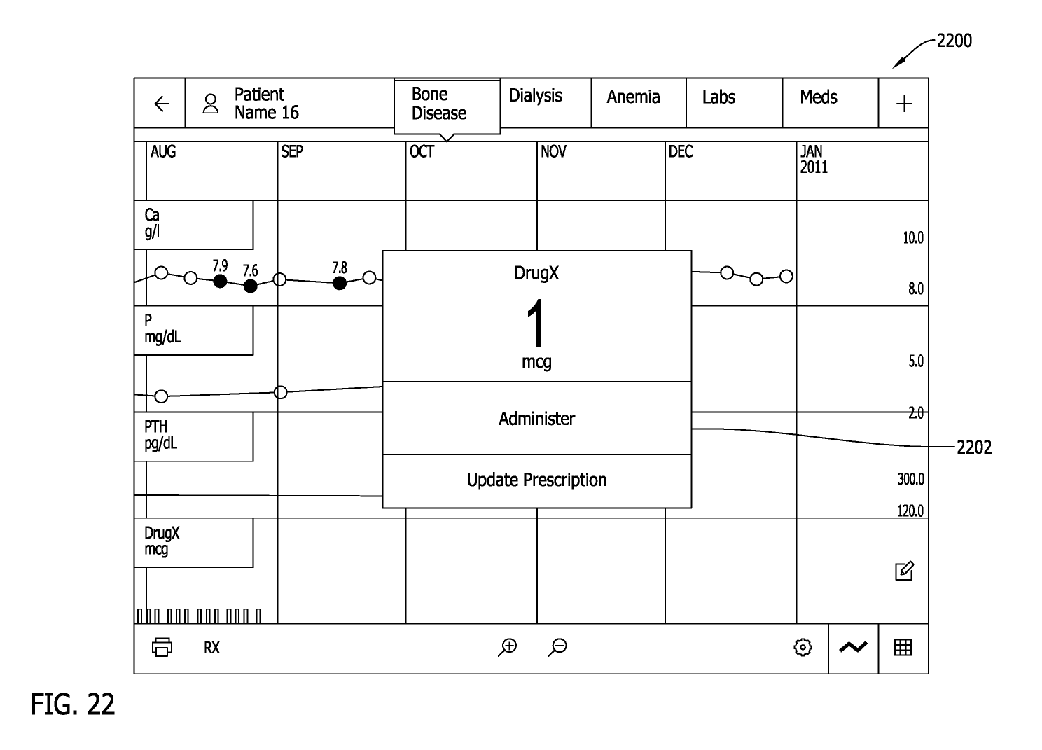

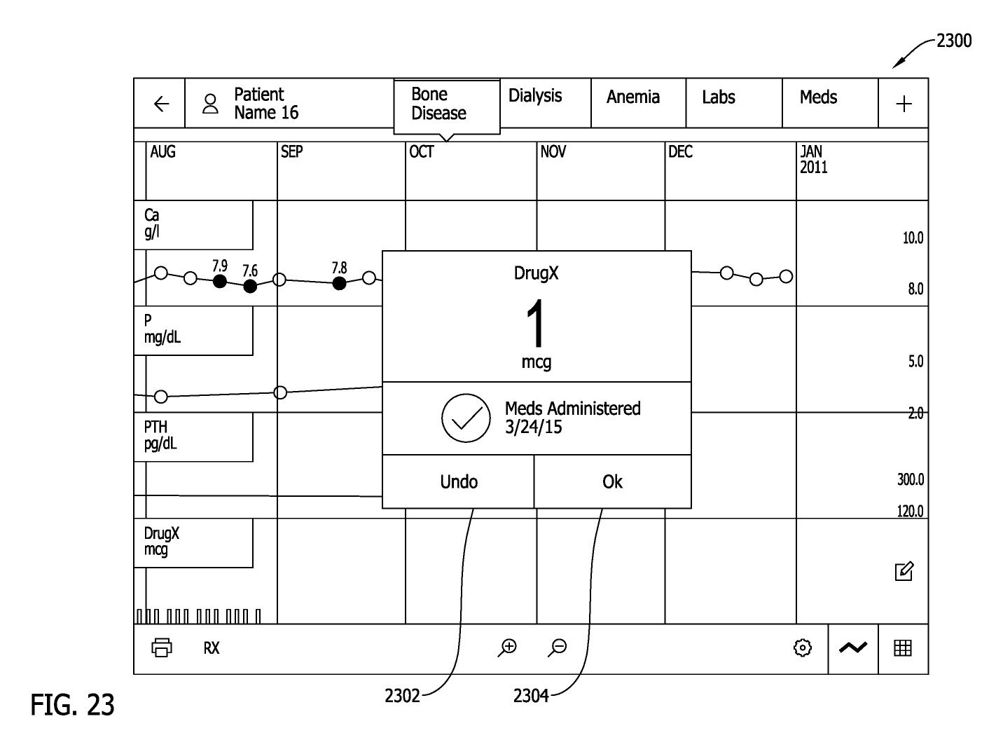

System 500 also allows the user of HCP computing device 504 to i) record when medication has been administered to the patient and/or ii) prescribe new medication. Referring back to FIG. 12, to record administration of medication, the user selects a record administration button 1270. FIG. 22 shows a medication administration window 2200 displayed when the user selects record administration button 1270. By selecting an administer button 2202, the displayed patient data is updated with the recorded administration, and a confirmation window 2300 (shown in FIG. 23) is displayed. Confirmation window 2300 includes an undo button 2302 that allows the user to remove the recording of the medication administration, and a confirmation button 2304 that allows the user to confirm the recording of the medication administration. In the example embodiment, data representing recorded medication administrations is transmitted to cloud server 502, and subsequently, dialysis clinic EMR/EHR server 510 and the pertinent servers/databases connected thereto.

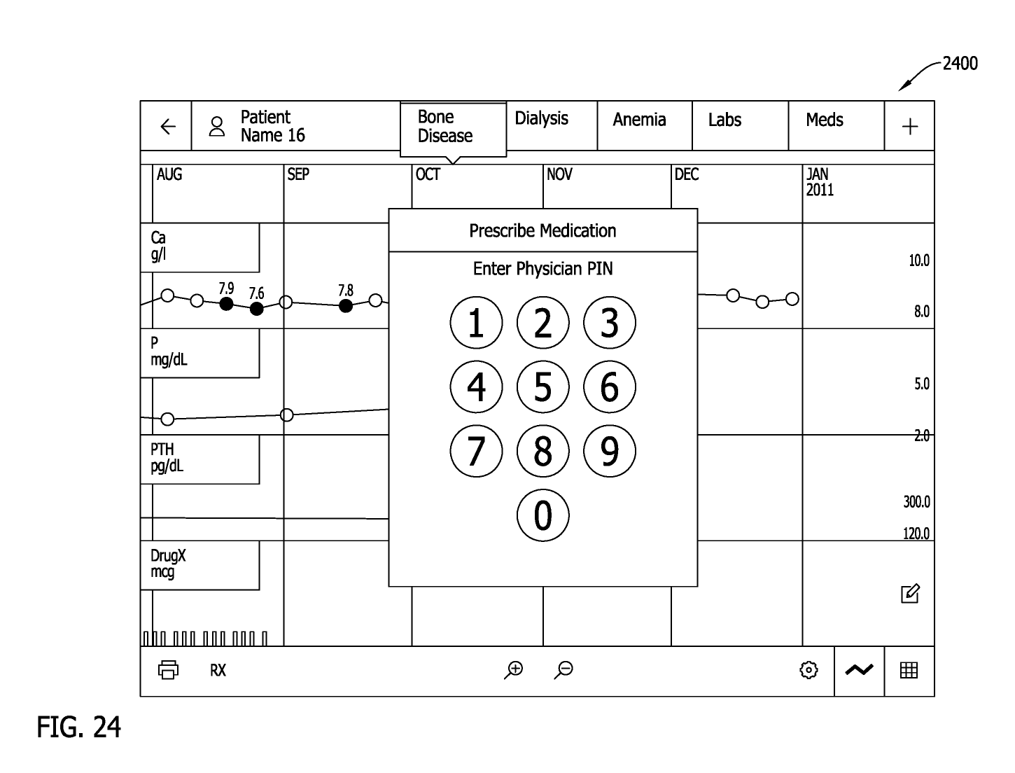

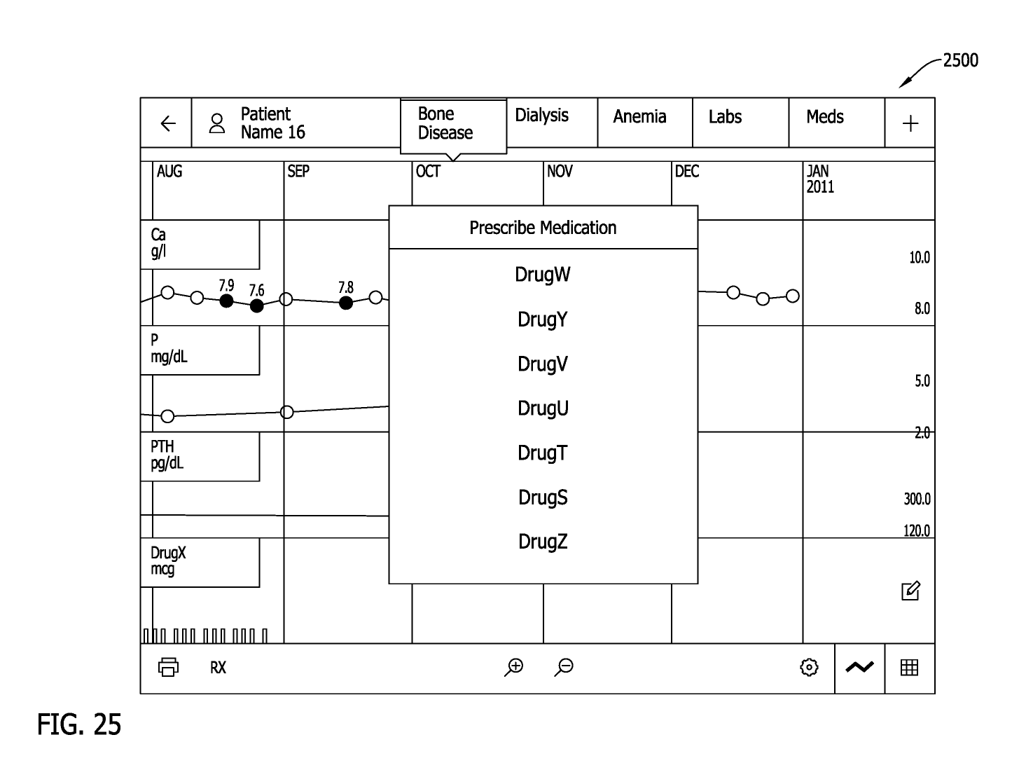

Referring back to FIG. 12, to prescribe medication to a patient, the user selects a prescription button 1280. FIG. 24 is a screenshot of a PIN window 2400 displayed when the user selects prescription button 1280. To verify that the user is authorized to prescribe medication, PIN window 2400 requires the user to enter a PIN prior to prescribing medication. Once the user enters the correct PIN, a medication selection window 2500 (shown in FIG. 25) is displayed. Medication selection window 2500 allows the user to select the medication to be prescribed from a list of medications.

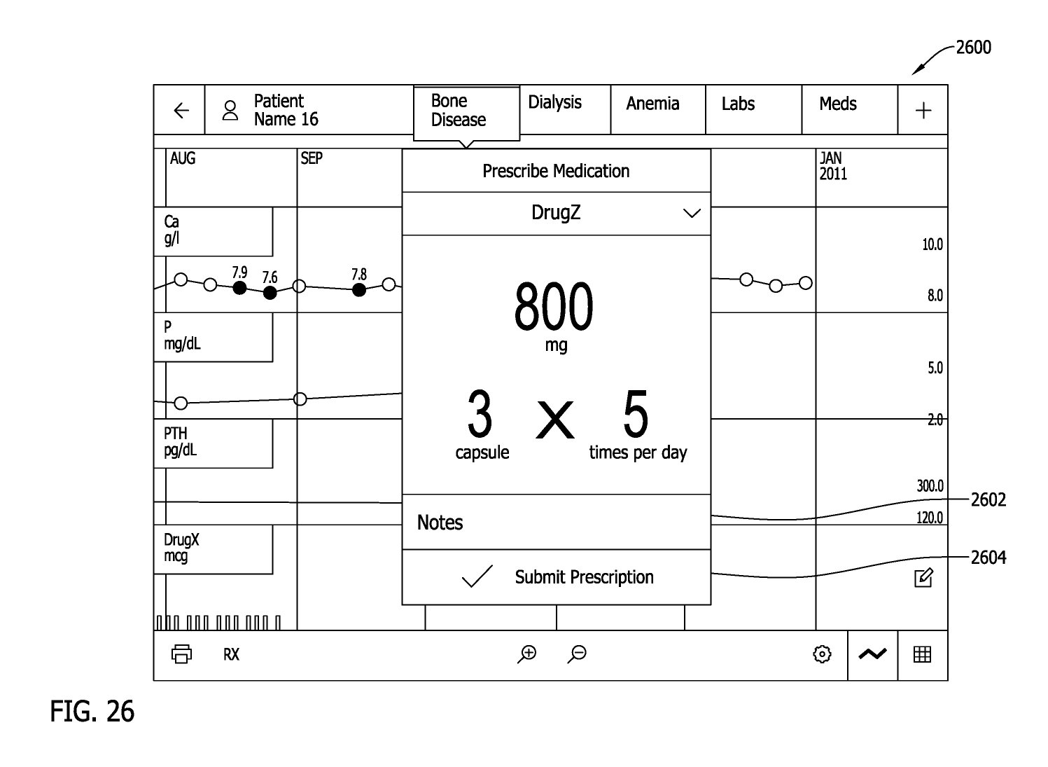

Once a medication is selected, a dosage window 2600 (shown in FIG. 26) is displayed. Dosage window 2600 allows the user to specify the prescribed dosage for the selected medication. Dosage window 2600 also includes a notes field 2602 that, when selected, allows the user to enter notes associated with the prescription. To submit the prescription, the user selects a submit prescription button 2604. This causes prescription data for the prescription to be transmitted to cloud server 502, and subsequently, dialysis clinic EMR/EHR server 510 and the pertinent servers/databases connected thereto (e.g., pharmacy EMR/EHR server 514).

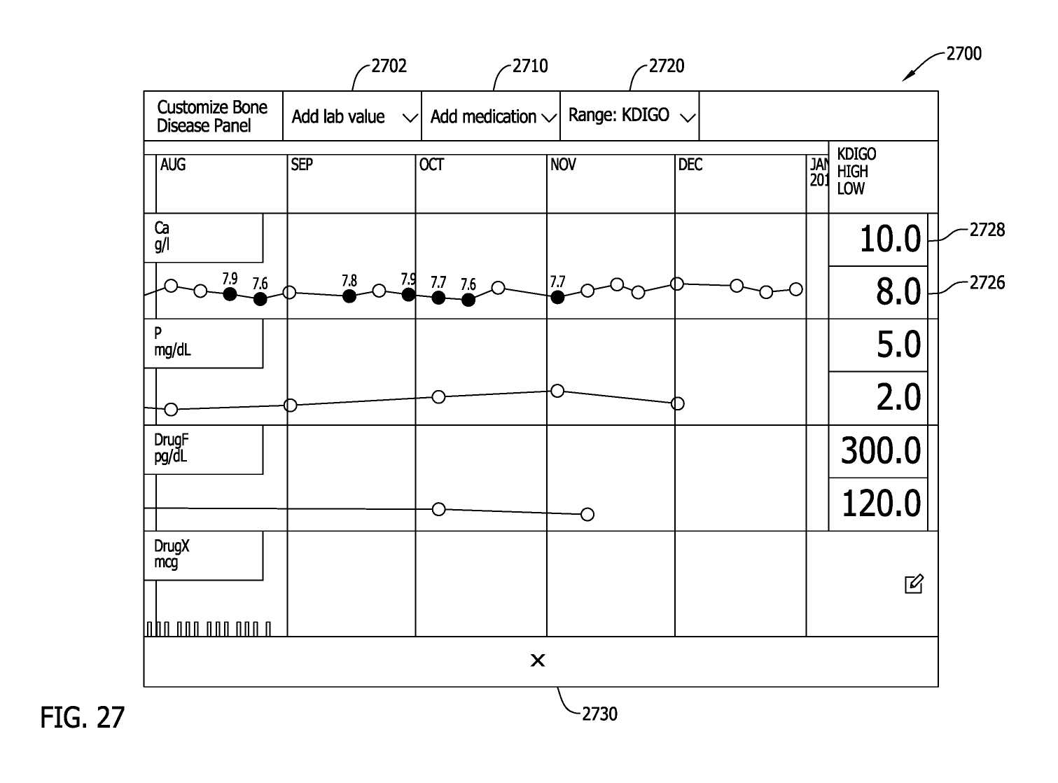

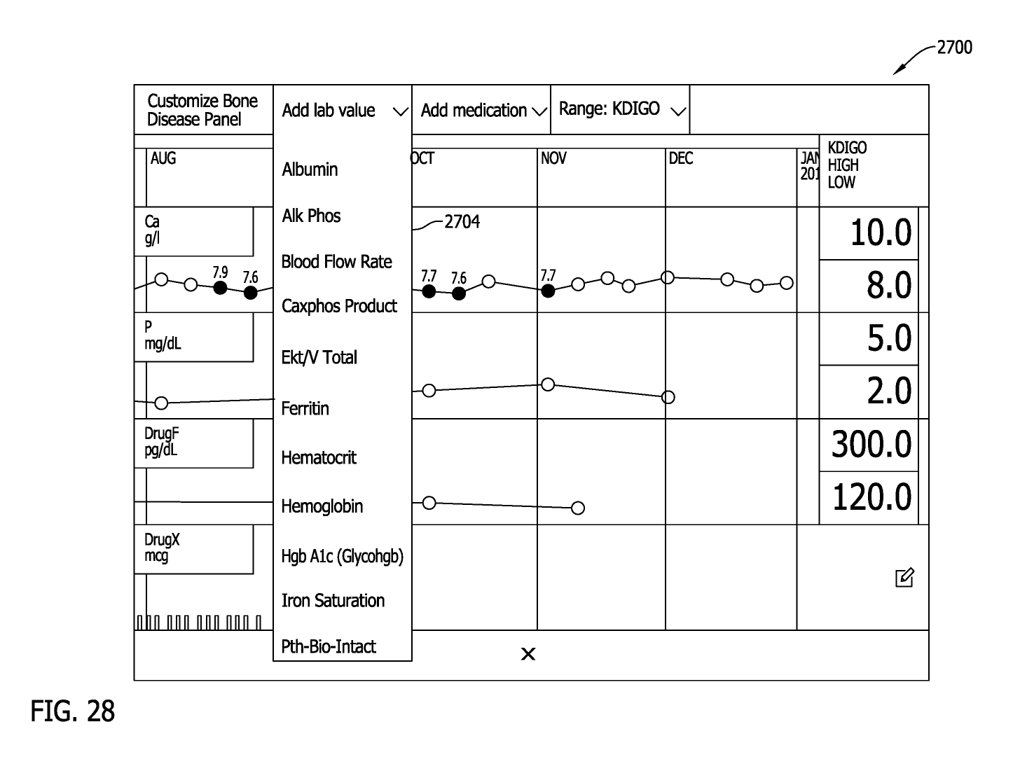

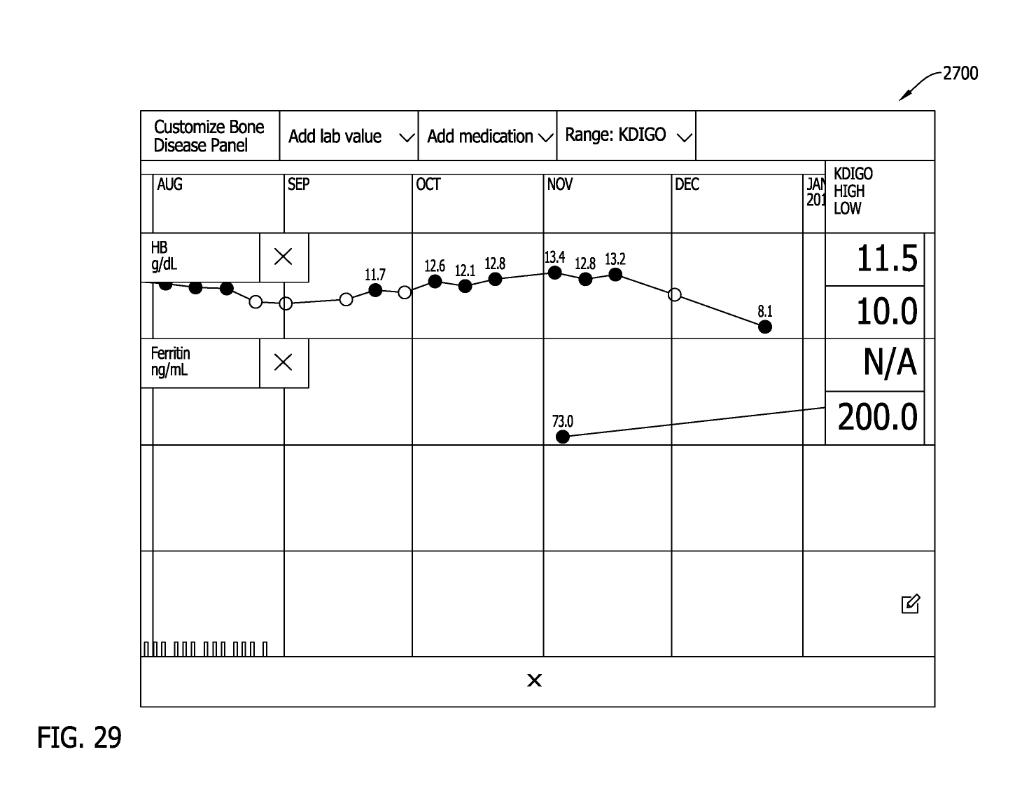

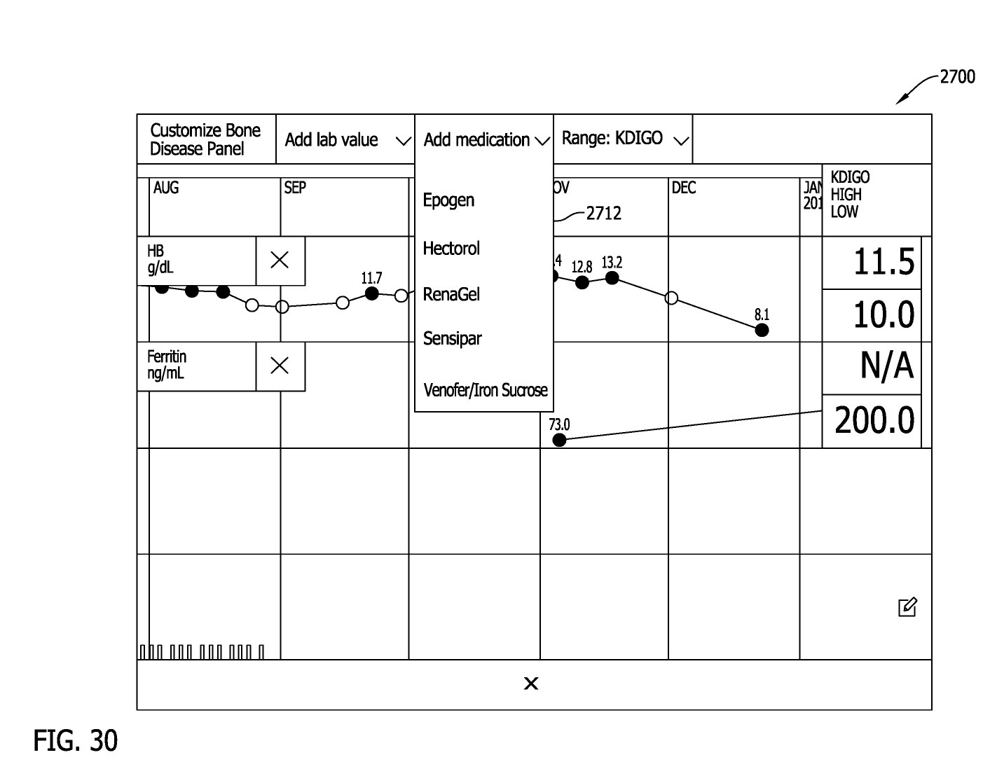

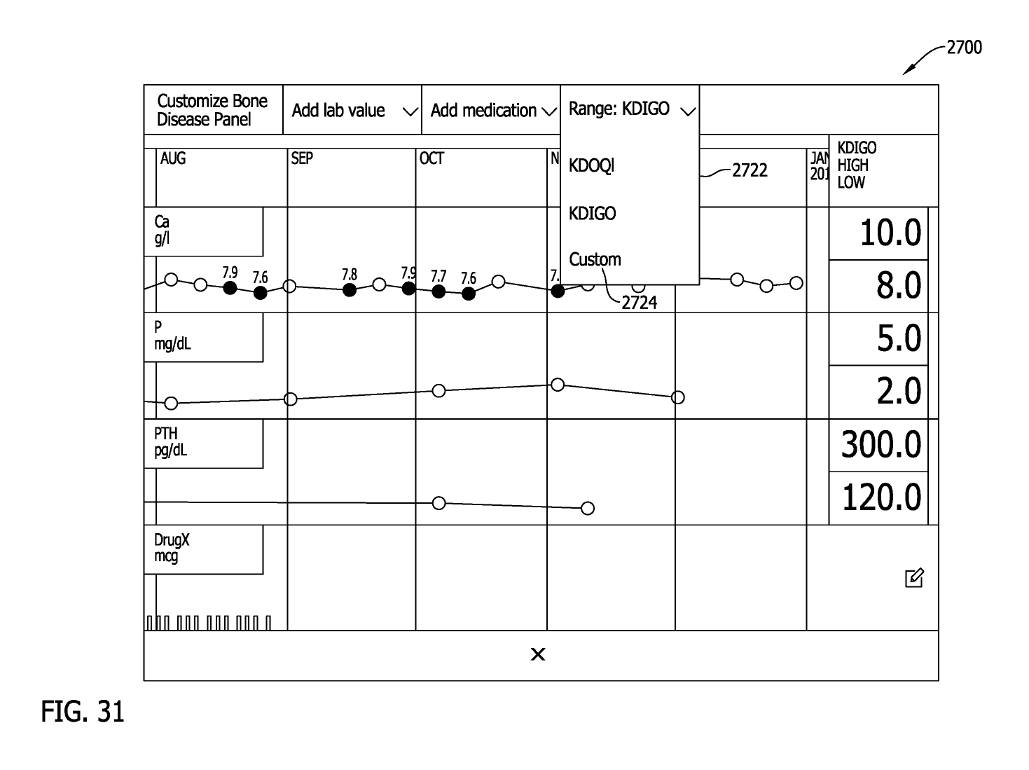

In the example embodiment, the data displayed in patient data window 1200 can be customized. Referring back to FIG. 12, to customize which patient data is displayed, the user selects a settings button 1285. FIG. 27 is a screenshot of a customization window 2700 that is displayed when the user selects settings button 1285. Customization window 2700 enables the user to control what data is displayed in patient data window 1200. When the user selects an add lab value button 2702, as shown in FIG. 28, a lab drop down list 2704 of addable lab values is displayed. FIG. 29 shows a screenshot of customization window 2700 after two lab values (e.g., HB and Ferritin) have been added for display by selecting them from drop down list 2704. Similarly, medications can be added by selecting an add medication button 2710 to display a medication drop down list 2712 (shown in FIG. 30), and the predetermined ranges displayed can be selected by selecting a range button 2720 to display a range drop down list 2722 (shown in FIG. 31).

By selecting a custom option 2724 from range drop down list 2722, the user can specify an upper threshold 2726 and a lower threshold 2728 that define the predetermined range for each displayed parameter. Referring back to FIG. 27, selecting a back button 2730 causes patient data window 1200 to be displayed, with the customized data included.

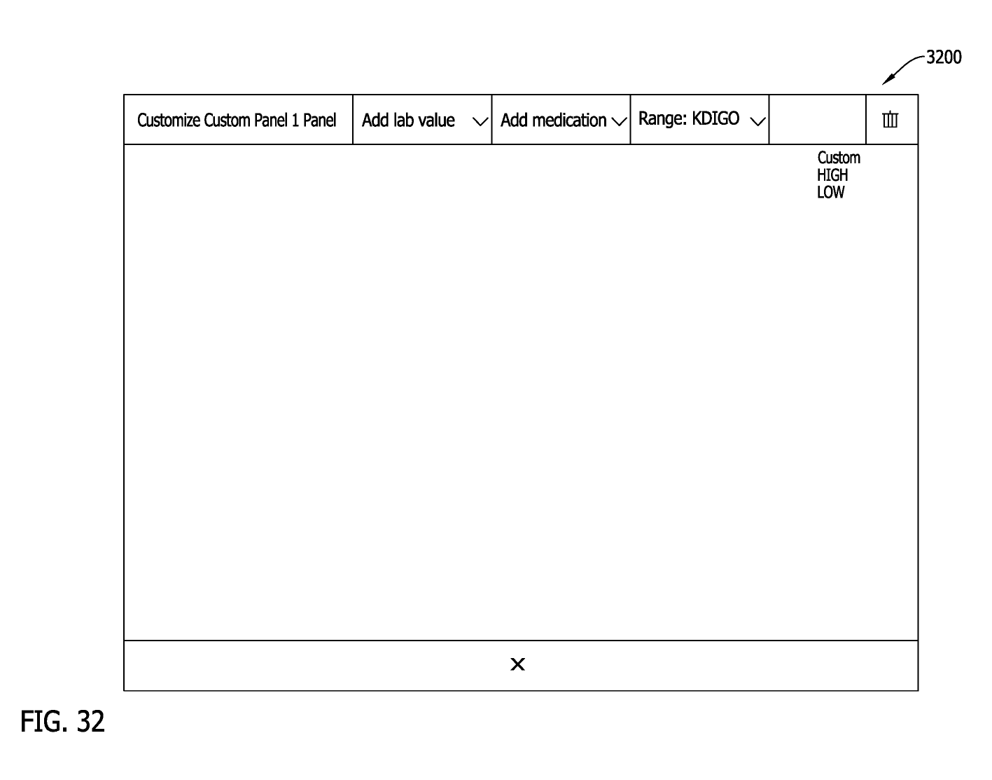

Referring back to FIG. 12, in addition to customizing information displayed on the predefined tabs of patient data window 1200 (e.g., bone disease tab 1202, dialysis tab 1204, anemia tab 1206, labs tab 1208, and meds tab 1210), the user can also add custom tabs by selecting an add tab button 1290. FIG. 32 is a screenshot of a new tab customization window 3200 that is displayed when add tab button 1290 is selected. Notably, new tab customization window 3200 includes substantially the same functionality as customization window 2700 (shown in FIG. 27).

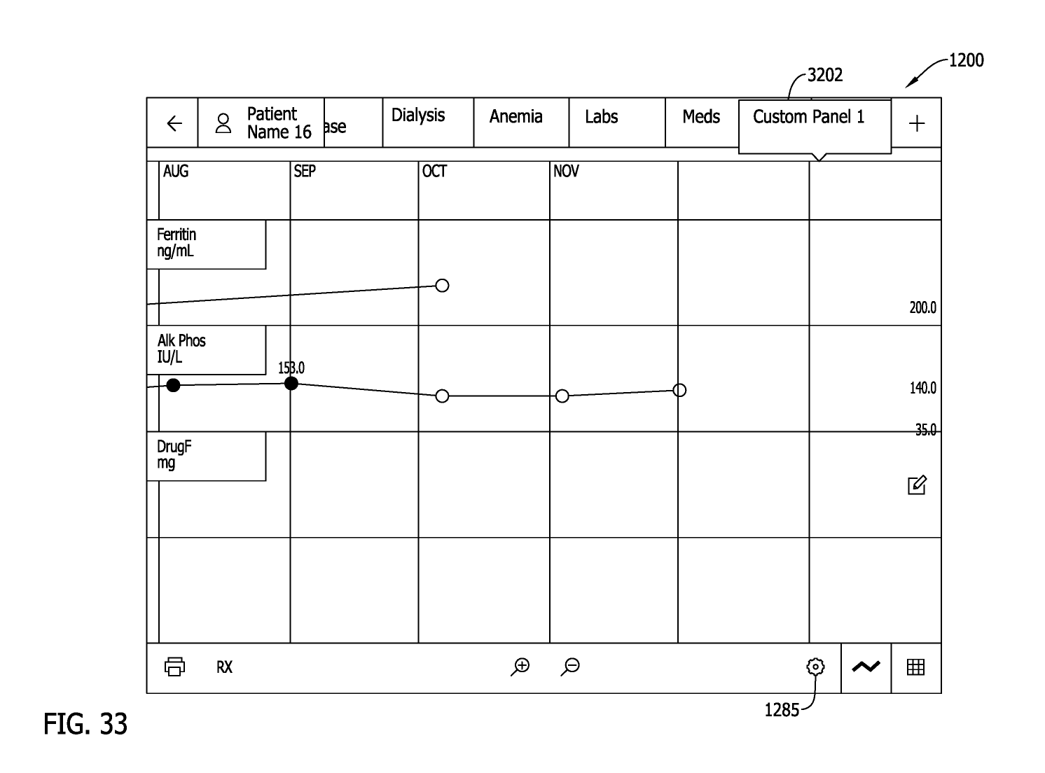

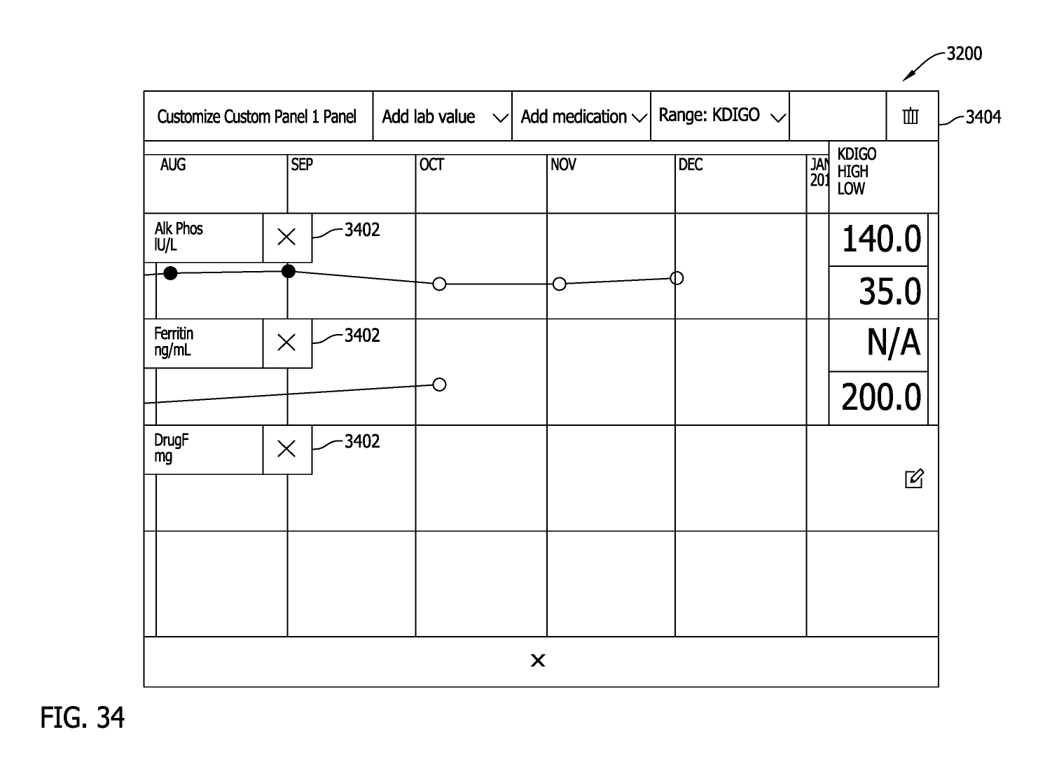

After the user has specified and confirmed which data should appear, patient data window 1200 includes a custom tab 3202 (shown in FIG. 33) that includes the specified data. To edit the information displayed when custom tab 3202 is selected, the user selects settings button 1285 while custom tab 3202 is selected. As shown in FIG. 34, the user can delete one or more displayed parameters by selecting an associated delete parameter button 3402. Further, the user can delete the entire custom tab 3202 by selecting a delete tab button 3404. Parameters added to predefined tabs can be similarly removed by selecting settings button 1285 while the predefined tab including the parameter(s) to be removed is selected.

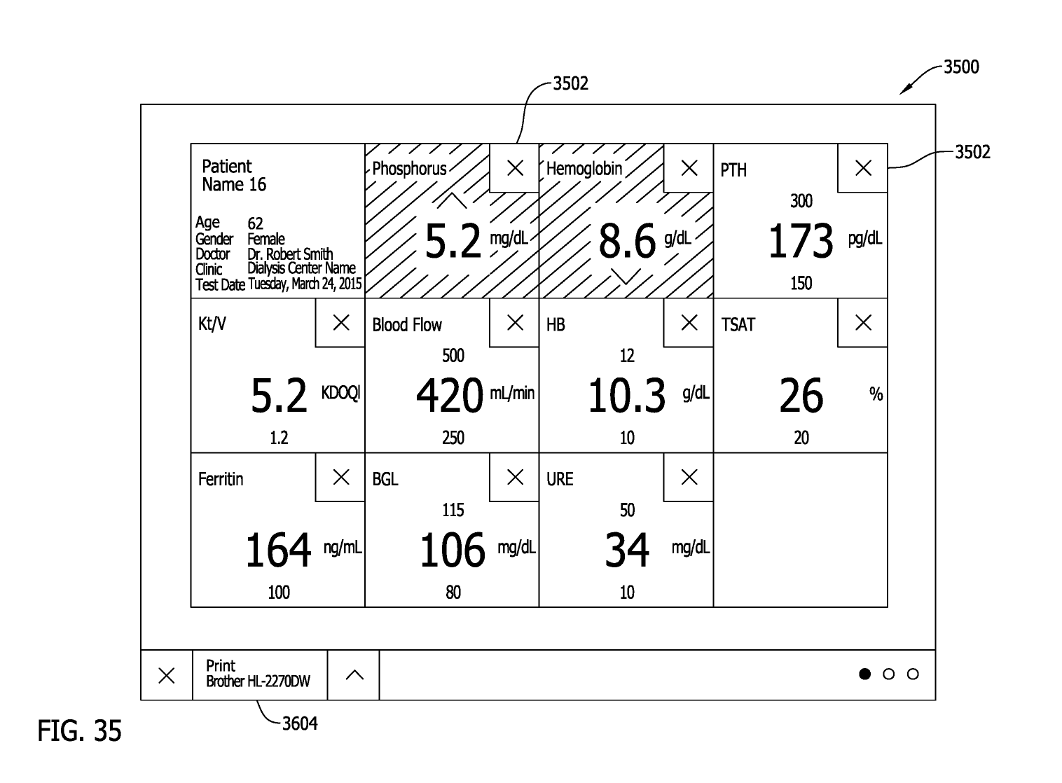

Referring back to FIG. 12, the user can generate a patient report by selecting a report button 1295. FIG. 35 is a screenshot of a lab value selection window 3500 that is displayed when report button 1295 is selected. Lab value selection window 3500 enables the user to select which lab values are to be included in the patient report. By clicking an exclude button 3502, an associated lab value will not be included in the patient report. Notably, lab values on lab value selection window 3500 that are outside the associated predetermined range are displayed in a different color (e.g., orange) than lab values that fall within the associated predetermined range.

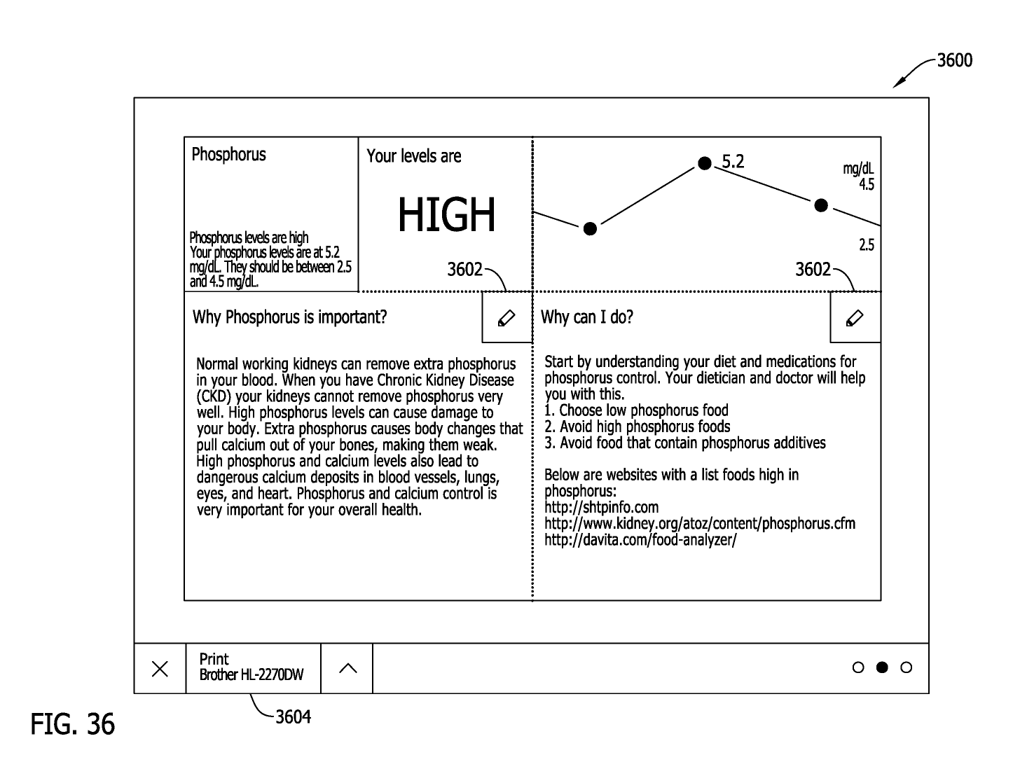

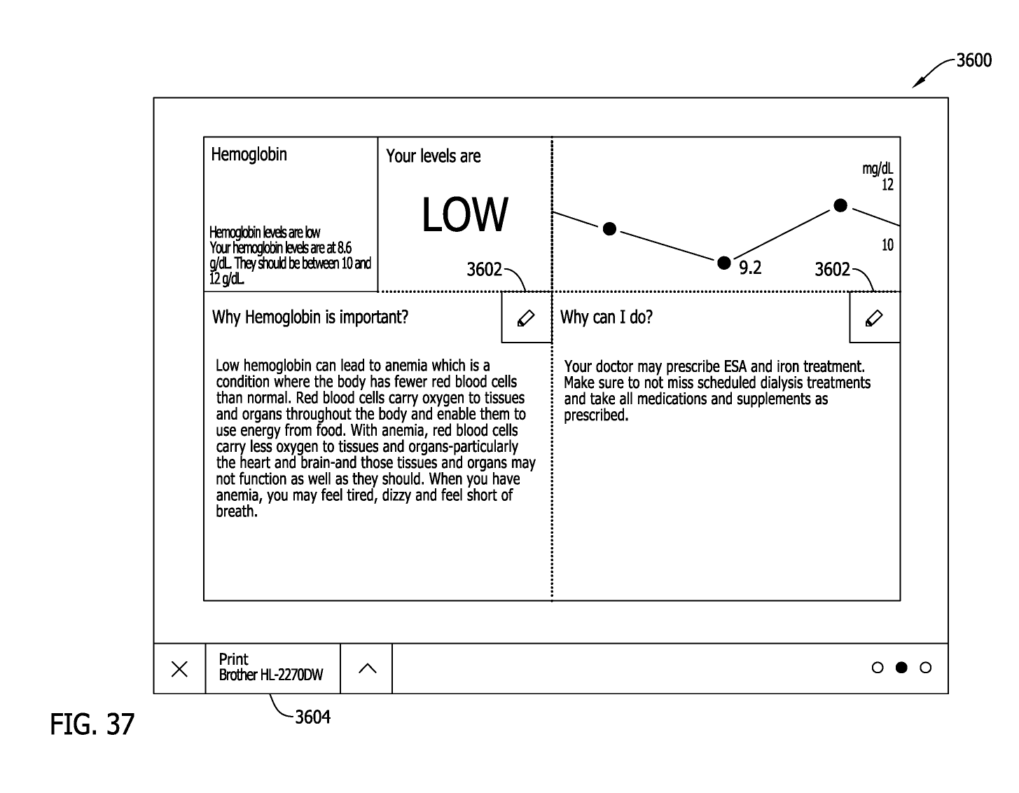

FIG. 36 is a screenshot of a first lab value report screen 3600 for a first selected lab value (e.g., phosphorous). First lab value report screen 3600 is displayed when a user scrolls or swipes away from the lab value selection window 3500. By selecting an edit button 3602, the user can add text or edit existing text for the patient report. FIG. 37 is a screenshot of a second lab value report screen 3700 for a second selected lab value (e.g., hemoglobin). Second lab value report screen 3700 includes the same functionality as first lab value report screen 3600. To print the patient report, the user selects a print button 3604. The patient report explains the patient's condition and treatment in straightforward, easy to understand terms, includes supplemental educational content, and may include links to additional reference materials.

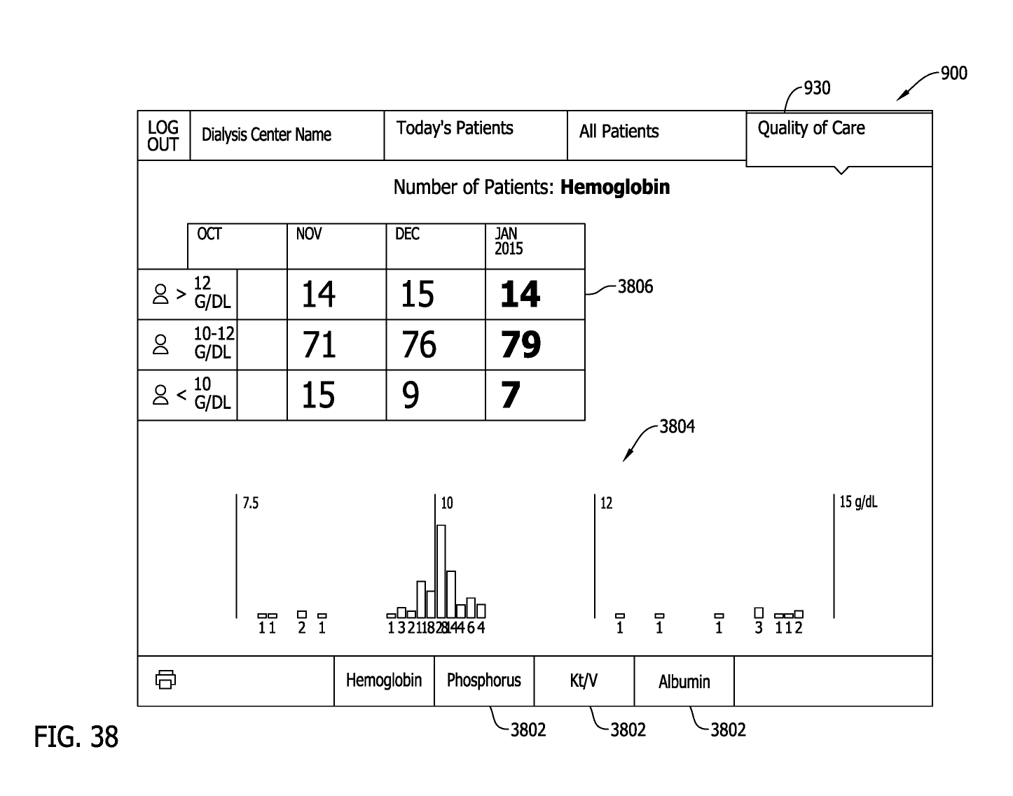

Referring back to FIG. 9, dashboard window 900 includes a quality of care tab 930. FIG. 38 shows a screenshot of dashboard window 900 with quality of care tab 930 selected. As shown in FIG. 38, when quality of care tab 930 is selected, dashboard window 900 displays metrics for selected parameters. In FIG. 38, metrics for hemoglobin are displayed. By selecting other parameter buttons 3802, metrics for other parameters are displayed.

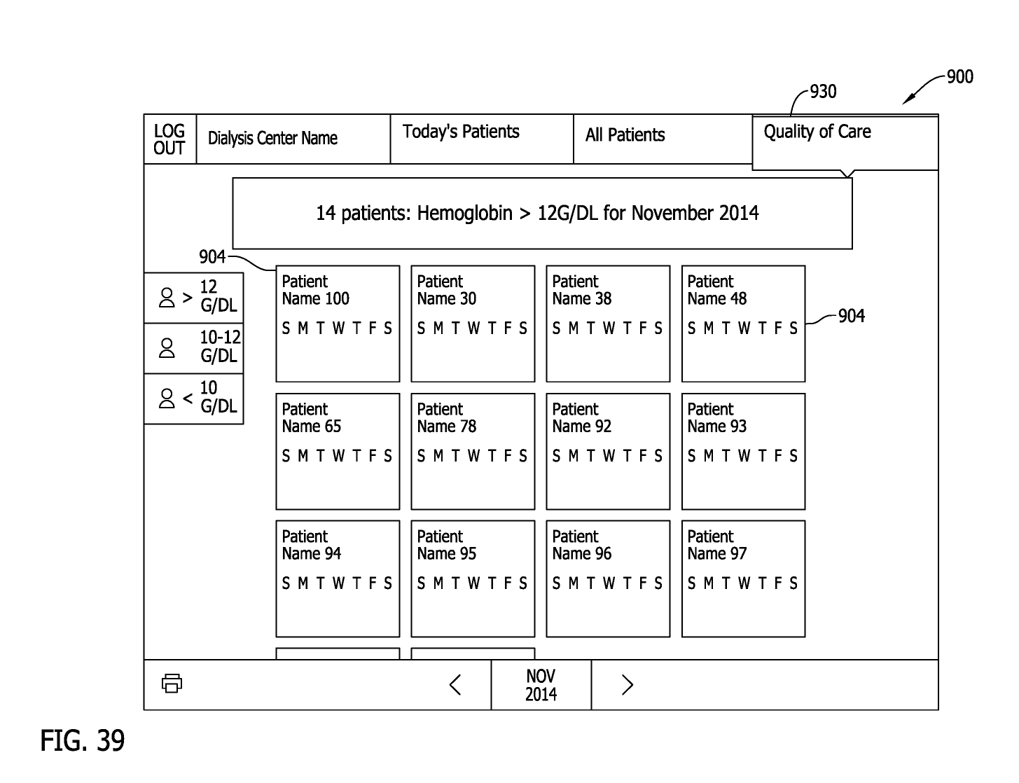

For a given parameter, in the example embodiment, the metrics includes a monthly breakdown indicating how many patients out of all of the patients are above the upper threshold (e.g., 12 G/DL) of the associated predetermined range, how many patients are within the predetermined range (e.g., 10-12 G/DL), and how many patients are below the lower threshold (e.g., 12 G/DL) of the associated predetermined range. Further, the user can select a month (e.g., by scrolling left and right) to display a graphical breakdown 3804 for the selected month. The information displayed on dashboard window 900 may be used by the HCP, for example, to track quality measure attainment for reimbursement purposes. Selecting a patient count 3806 causes patient panels 904 for patients included in patient count 3806 to be displayed, as shown in FIG. 39. Any of displayed patient panels 904 can be selected to display patient data window 1200 for the associated patient.

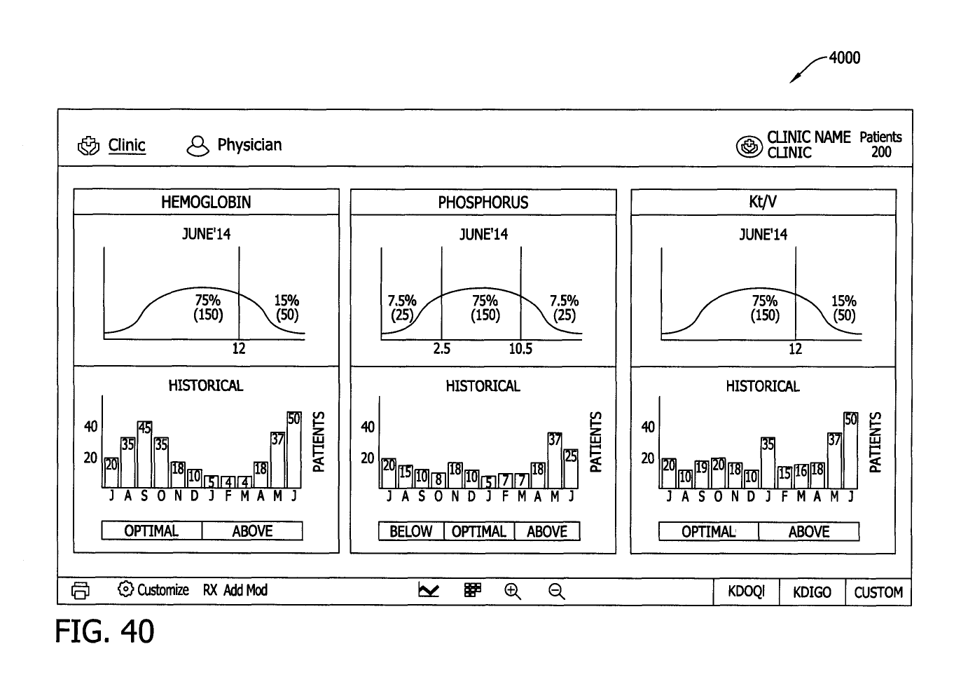

In some embodiments, the metrics are displayed as one or more graphs. For example, FIG. 40 is a screenshot of an alternative dashboard window 4000. In dashboard window 4000, the monthly breakdown of multiple parameters (e.g., hemoglobin, phosphorous, Kt/V) is shown. For example, dashboard window 4000 indicates that in June of 2014, twenty-five patients were below a lower threshold of a predetermined range, fifty patients were within the predetermined range, and twenty-five patients were above an upper threshold of the predetermined range.

In some embodiments, the systems and methods described herein are used to improve patient adherence. For example, by providing patients with the patient reports described herein, patients may be more engaged in the process and more willing to continue taking medication. That is, the patient reports enable patients to have more knowledge about their disease and treatment status, and graphically display patient treatment progress. With improved patient adherence, a smaller number of clinical trials and patients may be needed to test efficacy of a particular drug.

In at least some healthcare environments, lab parameters and medication parameters are recorded by hand, creating a plurality of disparate reports. Further, in existing systems, to effectively track patient data, the same data may need to be re-entered into multiple different applications (e.g., an EMR application, a pharmacy application, etc.). In contrast, the systems and methods described herein improve the accuracy and organization of lab and medication data for patients, and eliminate redundant data entry. The systems and methods described herein also display lab and medication parameters in a clear, visual display to facilitate efficient data analysis and improved treatment decisions by healthcare professionals, enabling healthcare professionals to spend additional time with patients. As described herein, the HCP can view and rearrange the displayed data as needed to easily identify trends. Further, the systems and methods described herein ensure that private patient data is only accessible by authorized parties. Accordingly, the embodiments described herein allow HCPs to enter prescriptions and track the administration of prescribed medication (e.g., to identify inconsistencies between prescribed and administered medication) and medical issues using a single tool. The data is displayed in an intuitive format to facilitate communication with the patient and to generate useful reports for the patient.

As will be appreciated based on the foregoing specification, the above-described embodiments of the disclosure may be implemented using computer programming or engineering techniques including computer software, firmware, hardware or any combination or subset thereof, wherein the technical effect of the systems and processes described herein is achieved by creating a system for retrieving and displaying patient data such that trends may be identified. Any such resulting program, having computer-readable code means, may be embodied or provided within one or more computer-readable media, thereby making a computer program product, e.g., an article of manufacture, according to the discussed embodiments of the disclosure. The computer-readable media may be, for example, but is not limited to, a fixed (hard) drive, diskette, optical disk, magnetic tape, semiconductor memory such as read-only memory (ROM), and/or any transmitting/receiving medium such as the Internet or other communication network or link. The article of manufacture containing the computer code may be made and/or used by executing the code directly from one medium, by copying the code from one medium to another medium, or by transmitting the code over a network.

This written description uses examples to disclose the embodiments, including the best mode, and also to enable any person skilled in the art to practice the disclosure, including making and using any devices or systems and performing any incorporated methods. The patentable scope of the embodiments is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A computer-implemented method for tracking electronic patient data over time, the method comprising:
retrieving, at a trend tracking computing device, electronic patient data from at least one server system, the electronic patient data including values acquired over a period of time for a plurality of parameters, the plurality of parameters including at least a lab parameter and a medication parameter;
transmitting, in response to a user input on a healthcare provider (HCP) computing device, the electronic patient data to the HCP computing device from the trend tracking computing device; and
controlling, using the trend tracking computing device, the HCP computing device to cause the electronic patient data to be displayed on the HCP computing device such that a user can observe trends in the electronic patient data over time.

2. The computer-implemented method of claim 1, wherein retrieving electronic patient data comprises retrieving electronic patient data associated with a plurality of patients on dialysis.

3. The computer-implemented method of claim 1, further comprising generating, using the trend tracking computing device, a printable patient report to improve patient adherence, wherein the printable patient report includes at least a portion of the electronic patient data.

4. The computer-implemented method of claim 1, wherein controlling the HCP computing device comprises controlling the HCP computing device to display, for one parameter of the plurality of parameters, an indication of how many patients in a patient population have a value for the one parameter that falls within a predetermined range.

5. The computer-implemented method of claim 1, wherein retrieving electronic patient data comprises retrieving electronic patient data from a clinic electronic medical record (EMR)/electronic health record (EHR) server, and wherein the clinic EMR/EHR server is communicatively coupled to a lab EMR/EHR server, a pharmacy EMR/EHR server, and a hospital EMR/EHR server.

6. The computer-implemented method of claim 5, further comprising:
generating, using the trend tracking computing device, an electronic prescription based on inputs received at the HCP computing device; and
transmitting the electronic prescription from the trend tracking computing device to the pharmacy EMR/EHR server via the clinic EMR/EHR server.

7. The computer-implemented method of claim 1, further comprising controlling, using the trend tracking computing device, the HCP computing device to cause a plurality of patient panels to be displayed on the HCP computing device, each patient panel associated with an individual patient that attends a dialysis clinic.

8. A trend tracking computing device for tracking electronic patient data over time, the trend tracking computing device configured to:
retrieve electronic patient data from at least one server system, the electronic patient data including values acquired over a period of time for a plurality of parameters, the plurality of parameters including at least a lab parameter and a medication parameter;
transmit, in response to a user input on a healthcare provider (HCP) computing device, the electronic patient data to the HCP computing device from the trend tracking computing device; and
control the HCP computing device to cause the electronic patient data to be displayed on the HCP computing device such that a user can observe trends in the electronic patient data over time.

9. The trend tracking computing device of claim 8, wherein to retrieve electronic patient data, the trend tracking computing device is configured to retrieve electronic patient data associated with a plurality of patients on dialysis.

10. The trend tracking computing device of claim 8, wherein the trend tracking computing device is further configured to generate a printable patient report to improve patient adherence, wherein the printable patient report includes at least a portion of the electronic patient data.

11. The trend tracking computing device of claim 8, wherein to control the HCP computing device, the trend tracking computing device is configured to control the HCP computing device to display, for one parameter of the plurality of parameters, an indication of how many patients in a patient population have a value for the one parameter that falls within a predetermined range.

12. The trend tracking computing device of claim 8, wherein to retrieve electronic patient data, the trend tracking computing device is configured to retrieve electronic patient data from a clinic electronic medical record (EMR)/electronic health record (EHR) server, and wherein the clinic EMR/EHR server is communicatively coupled to a lab EMR/EHR server, a pharmacy EMR/EHR server, and a hospital EMR/EHR server.

13. The trend tracking computing device of claim 12, wherein the trend tracking computing device is further configured to:
generate an electronic prescription based on inputs received at the HCP computing device; and
transmit the electronic prescription to the pharmacy EMR/EHR server via the clinic EMR/EHR server.

14. The trend tracking computing device of claim 8, wherein the trend tracking computing device is further configured to control the HCP computing device to cause a plurality of patient panels to be displayed on the HCP computing device, each patient panel associated with an individual patient that attends a dialysis clinic.

15. A computer system for tracking electronic patient data over time, the computer system comprising:
a healthcare provider (HCP) computing device;
at least one server system; and
a trend tracking computing device communicatively coupled to the HCP computing device and the at least one server system, the trend tracking computing device configured to:
retrieve electronic patient data from the at least one server system, the electronic patient data including values acquired over a period of time for a plurality of parameters, the plurality of parameters including at least a lab parameter and a medication parameter;
transmit, in response to a user input on the HCP computing device, the electronic patient data to the HCP computing device from the trend tracking computing device; and
control, the HCP computing device to cause the electronic patient data to be displayed on the HCP computing device such that a user can observe trends in the electronic patient data over time.

16. The computer system of claim 15, wherein to retrieve electronic patient data, the trend tracking computing device is configured to retrieve electronic patient data associated with a plurality of patients on dialysis.

17. The computer system of claim 15, wherein the trend tracking computing device is further configured to generate a printable patient report to improve patient adherence, wherein the printable patient report includes at least a portion of the electronic patient data.

18. The computer system of claim 15, wherein to control the HCP computing device, the trend tracking computing device is configured to control the HCP computing device to display, for one parameter of the plurality of parameters, an indication of how many patients in a patient population have a value for the one parameter that falls within a predetermined range.

19. The computer system of claim 15, wherein the at least one server system comprises a clinic electronic medical record (EMR)/electronic health record (EHR) server, and wherein the clinic EMR/EHR server is communicatively coupled to a lab EMR/EHR server, a pharmacy EMR/EHR server, and a hospital EMR/EHR server.

20. The computer system of claim 19, wherein the trend tracking computing device is further configured to:
generate an electronic prescription based on inputs received at the HCP computing device; and
transmit the electronic prescription to the pharmacy EMR/EHR server via the clinic EMR/EHR server.
